(19) United States
(12) Patent Application Publication
(10) Pub. No.: US 2025/0378335 A1
(43) Pub. Date: Dec. 11, 2025

(54) DETERMINING QUANTIZATION INFORMATION

(71) Applicant: QUALCOMM Incorporated, San Diego, CA (US)

(72) Inventors: June NAMGOONG, San Diego, CA (US); Taesang YOO, San Diego, CA (US); Yiyue CHEN, San Diego, CA (US); Abdelrahman Mohamed Ahmed Mohamed IBRAHIM, San Diego, CA (US); Jay Kumar SUNDARARAJAN, San Diego, CA (US); Chenxi HAO, Beijing (CN)

(21) Appl. No.: 18/876,145

(22) PCT Filed: Aug. 11, 2022
(86) PCT No.: PCT/CN2022/111650

§ 371 Date: Dec. 17, 2024

(51) Int. Cl. G06N 3/084; G06N 3/0455; H04L 5/00

(52) U.S. Cl. CPC G06N 3/084; G06N 3/0455; H04L 5/0091

(57) ABSTRACT

Aspects relate to encoder and decoder training. In some examples, a first server selects a quantization scheme for encoder and decoder training with a second server. In addition, the first server may determine codebook information based on the encoder and decoder training. The first server may then transmit the codebook information and an indication of the selected quantization scheme to the second server.

### TECHNICAL FIELD

The technology discussed below relates generally to wireless communication and, more particularly, to determining quantization information for wireless communication applications.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A base station may schedule access to a cell to support access by multiple UEs. For example, a base station may allocate different resources (e.g., time domain and frequency domain resources) to be used by different UEs operating within the cell. Thus, each UE may transmit information to the BS via one or more of these resources and/or the BS may transmit information to one or more of the UEs via one or more of these resources. In some examples, the transmission of information may involve encoding information by an encoder of a corresponding transmitter. In addition, the reception of information may involve decoding information by a decoder of a corresponding receiver.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a method for communication at a first server is disclosed. The method may include communicating with a second server to identify a set of quantization schemes for encoder and decoder training. The method may also include communicating with the second server to conduct the encoder and decoder training. The method may further include transmitting, to the second server, codebook information generated by the first server and an indication of a first quantization scheme selected by the first server from the set of quantization schemes. The method may additionally include transmitting encoder information to at least one user equipment associated with the first server. In some examples, the encoder information is based on the encoder and decoder training, the codebook information, and the first quantization scheme.

In some examples, a first server may include a transceiver, a memory, and a processor coupled to the transceiver and the memory. The processor and the memory may be configured to communicate with a second server to identify a set of quantization schemes for encoder and decoder training. The processor and the memory may also be configured to communicate with the second server to conduct the encoder and decoder training. The processor and the memory may further be configured to transmit, to the second server, codebook information generated by the first server and an indication of a first quantization scheme selected by the first server from the set of quantization schemes. The processor and the memory may additionally be configured to transmit encoder information to at least one user equipment associated with the first server. In some examples, the encoder information is based on the encoder and decoder training, the codebook information, and the first quantization scheme.

In some examples, a first server may include means for communicating with a second server to identify a set of quantization schemes for encoder and decoder training. The first server may also include means for communicating with the second server to conduct the encoder and decoder training. The first server may further include means for transmitting, to the second server, codebook information generated by the first server and an indication of a first quantization scheme selected by the first server from the set of quantization schemes. The first server may additionally include means for transmitting encoder information to at least one user equipment associated with the first server. In some examples, the encoder information is based on the encoder and decoder training, the codebook information, and the first quantization scheme.

In some examples, an article of manufacture for use by a first server includes a non-transitory computer-readable medium having stored therein instructions executable by one or more processors of the first server to communicate with a second server to identify a set of quantization schemes for encoder and decoder training. The computer-readable medium may also have stored therein instructions executable by one or more processors of the first server to communicate with the second server to conduct the encoder and decoder training. The computer-readable medium may further have stored therein instructions executable by one or more processors of the first server to transmit, to the second server, codebook information generated by the first server and an indication of a first quantization scheme selected by the first server from the set of quantization schemes. The computer-readable medium may additionally have stored therein instructions executable by one or more processors of the first server to transmit encoder information to at least one user equipment associated with the first server. In some examples, the encoder information is based on the encoder and decoder training, the codebook information, and the first quantization scheme.

In some examples, a method for communication at a first server is disclosed. The method may include communicating with a second server to identify a set of quantization schemes for encoder and decoder training. The method may also include communicating with the second server to conduct the encoder and decoder training. The method may further include receiving, from the second server, codebook information generated by the second server and an indication of a first quantization scheme selected by the second server from the set of quantization schemes. The method may additionally include transmitting decoder information to at least one network entity associated with the first server. In some examples, the decoder information is based on the encoder and decoder training, the codebook information, and the first quantization scheme.

In some examples, a first server may include a transceiver, a memory, and a processor coupled to the transceiver and the memory. The processor and the memory may be configured to communicate with a second server to identify a set of quantization schemes for encoder and decoder training. The processor and the memory may also be configured to communicate with the second server to conduct the encoder and decoder training. The processor and the memory may further be configured to receive, from the second server, codebook information generated by the second server and an indication of a first quantization scheme selected by the second server from the set of quantization schemes. The processor and the memory may additionally be configured to transmit decoder information to at least one network entity associated with the first server. In some examples, the decoder information is based on the encoder and decoder training, the codebook information, and the first quantization scheme.

In some examples, a first server may include means for communicating with a second server to identify a set of quantization schemes for encoder and decoder training. The first server may also include means for communicating with the second server to conduct the encoder and decoder training. The first server may further include means for receiving, from the second server, codebook information generated by the second server and an indication of a first quantization scheme selected by the second server from the set of quantization schemes. The first server may additionally include means for transmitting decoder information to at least one network entity associated with the first server. In some examples, the decoder information is based on the encoder and decoder training, the codebook information, and the first quantization scheme.

In some examples, an article of manufacture for use by a first server includes a non-transitory computer-readable medium having stored therein instructions executable by one or more processors of the first server to communicate with a second server to identify a set of quantization schemes for encoder and decoder training. The computer-readable medium may also have stored therein instructions executable by one or more processors of the first server to communicate with the second server to conduct the encoder and decoder training. The computer-readable medium may further have stored therein instructions executable by one or more processors of the first server to receive, from the second server, codebook information generated by the second server and an indication of a first quantization scheme selected by the second server from the set of quantization schemes. The computer-readable medium may additionally have stored therein instructions executable by one or more processors of the first server to transmit decoder information to at least one network entity associated with the first server. In some examples, the decoder information is based on the encoder and decoder training, the codebook information, and the first quantization scheme.

In some examples, a method for communication at a first server is disclosed. The method may include communicating with a second server to identify a set of quantization schemes for encoder and decoder training. The method may also include communicating with the second server to conduct the encoder and decoder training. The method may further include receiving, from the second server, codebook information generated by the second server and an indication of a first quantization scheme selected by the second server from the set of quantization schemes. The method may additionally include transmitting encoder information to at least one user equipment associated with the first server. In some examples, the encoder information is based on the encoder and decoder training, the codebook information, and the first quantization scheme.

In some examples, a first server may include a transceiver, a memory, and a processor coupled to the transceiver and the memory. The processor and the memory may be configured to communicate with a second server to identify a set of quantization schemes for encoder and decoder training. The processor and the memory may also be configured to communicate with the second server to conduct the encoder and decoder training. The processor and the memory may further be configured to receive, from the second server, codebook information generated by the second server and an indication of a first quantization scheme selected by the second server from the set of quantization schemes. The processor and the memory may additionally be configured to transmit encoder information to at least one user equipment associated with the first server. In some examples, the encoder information is based on the encoder and decoder training, the codebook information, and the first quantization scheme.

In some examples, a first server may include means for communicating with a second server to identify a set of quantization schemes for encoder and decoder training. The first server may also include means for communicating with the second server to conduct the encoder and decoder training. The first server may further include means for receiving, from the second server, codebook information generated by the second server and an indication of a first quantization scheme selected by the second server from the set of quantization schemes. The first server may additionally include means for transmitting encoder information to at least one user equipment associated with the first server. In some examples, the encoder information is based on the encoder and decoder training, the codebook information, and the first quantization scheme.

In some examples, an article of manufacture for use by a first server includes a non-transitory computer-readable medium having stored therein instructions executable by one or more processors of the first server to communicate with a second server to identify a set of quantization schemes for encoder and decoder training. The computer-readable medium may also have stored therein instructions executable by one or more processors of the first server to communicate with the second server to conduct the encoder and decoder training. The computer-readable medium may further have stored therein instructions executable by one or more processors of the first server to receive, from the second server, codebook information generated by the second server and an indication of a first quantization scheme selected by the second server from the set of quantization schemes. The computer-readable medium may additionally have stored therein instructions executable by one or more processors of the first server to transmit encoder information to at least one user equipment associated with the first server. In some examples, the encoder information is based on the encoder and decoder training, the codebook information, and the first quantization scheme.

In some examples, a method for communication at a first server is disclosed. The method may include communicating with a second server to identify a set of quantization schemes for encoder and decoder training. The method may also include communicating with the second server to conduct the encoder and decoder training. The method may further include transmitting, to the second server, codebook information generated by the first server and an indication of a first quantization scheme selected by the first server from the set of quantization schemes. The method may additionally include transmitting decoder information to at least one network entity associated with the first server. In some examples, the decoder information is based on the encoder and decoder training, the codebook information, and the first quantization scheme.

In some examples, a first server may include a transceiver, a memory, and a processor coupled to the transceiver and the memory. The processor and the memory may be configured to communicate with a second server to identify a set of quantization schemes for encoder and decoder training. The processor and the memory may also be configured to communicate with the second server to conduct the encoder and decoder training. The processor and the memory may further be configured to transmit, to the second server, codebook information generated by the first server and an indication of a first quantization scheme selected by the first server from the set of quantization schemes. The processor and the memory may additionally be configured to transmit decoder information to at least one network entity associated with the first server. In some examples, the decoder information is based on the encoder and decoder training, the codebook information, and the first quantization scheme.

In some examples, a first server may include means for communicating with a second server to identify a set of quantization schemes for encoder and decoder training. The first server may also include means for communicating with the second server to conduct the encoder and decoder training. The first server may further include means for transmitting, to the second server, codebook information generated by the first server and an indication of a first quantization scheme selected by the first server from the set of quantization schemes. The first server may additionally include means for transmitting decoder information to at least one network entity associated with the first server. In some examples, the decoder information is based on the encoder and decoder training, the codebook information, and the first quantization scheme.

In some examples, an article of manufacture for use by a first server includes a non-transitory computer-readable medium having stored therein instructions executable by one or more processors of the first server to communicate with a second server to identify a set of quantization schemes for encoder and decoder training. The computer-readable medium may also have stored therein instructions executable by one or more processors of the first server to communicate with the second server to conduct the encoder and decoder training. The computer-readable medium may further have stored therein instructions executable by one or more processors of the first server to transmit, to the second server, codebook information generated by the first server and an indication of a first quantization scheme selected by the first server from the set of quantization schemes. The computer-readable medium may additionally have stored therein instructions executable by one or more processors of the first server to transmit decoder information to at least one network entity associated with the first server. In some examples, the decoder information is based on the encoder and decoder training, the codebook information, and the first quantization scheme.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a diagram providing a high-level illustration of one example of a configuration of a disaggregated base station according to some aspects.

FIG. 4 is a schematic illustration of wireless resources in an air interface utilizing orthogonal frequency divisional multiplexing (OFDM) according to some aspects.

FIG. 5 is a block diagram illustrating an example of wireless communication devices including an encoder and a decoder according to some aspects.

FIG. 6 is a conceptual illustration of an example of machine learning for an encoder and decoder according to some aspects.

FIG. 7 is a conceptual illustration of a gradient for a machine learning operation according to some aspects.

FIG. 8 is a diagram illustrating signaling for cross node machine learning according to some aspects.

FIG. 9 is a block diagram illustrating an example of encoding at a UE and decoding at a network entity (e.g., a gNB) according to some aspects.

FIG. 10 is a block diagram illustrating an example of cross node machine learning for a UE encoder and a network entity (e.g., a gNB) decoder according to some aspects.

FIG. 11 is a block diagram illustrating another example of cross node machine learning for a UE encoder and a network entity (e.g., a gNB) decoder according to some aspects.

FIG. 12 is a signaling diagram illustrating an example of cross node machine learning related signaling according to some aspects.

FIG. 13 is a signaling diagram illustrating another example of cross node machine learning related signaling according to some aspects.

FIG. 14 is a block diagram conceptually illustrating an example of a hardware implementation for a server employing a processing system according to some aspects.

FIG. 15 is a flow chart illustrating an example communication method involving cross node machine learning according to some aspects.

FIG. 16 is a flow chart illustrating an example communication method involving cross node machine learning according to some aspects.

FIG. 17 is a block diagram conceptually illustrating an example of a hardware implementation for a server employing a processing system according to some aspects.

FIG. 18 is a flow chart illustrating an example communication method involving cross node machine learning signaling according to some aspects.

FIG. 19 is a flow chart illustrating an example communication method involving cross node machine learning signaling according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

Various aspects of the disclosure relate to training an encoder and a decoder for communication applications. In some aspects, a machine learning operation is used to train the encoder and the decoder.

In some aspects, the machine learning is performed across communication nodes. For example, a first server of a vendor for a user equipment may cooperate with a second server of a vendor for a network entity (e.g., a base station) to train an encoder for the user equipment and a decoder for the network entity. In some examples, a plurality of servers of a plurality of user equipment vendors may cooperate with a server of a vendor for a network entity to train encoders for the user equipment of the different user equipment vendors and a decoder for the network entity.

The disclosure relates in some aspects to determining quantization information associated with an encoder that is trained across communication nodes. In some examples, the quantization information may include a learned codebook. In some examples, the quantization information may include a selected quantization scheme.

For example, a user equipment vendor may apply a particular quantization scheme based on a codebook used during a training operation. Once the training operation is completed, the user equipment vendor may send, to the network entity, vendor information associated with the codebook and the quantization scheme that was determined during the learning operation.

As another example, a network entity vendor may apply a particular quantization scheme based on a codebook used during a training operation. Once the training operation is completed, the network entity vendor may send, to the user equipment, vendor information associated with the codebook and the quantization scheme that was determined during the learning operation.

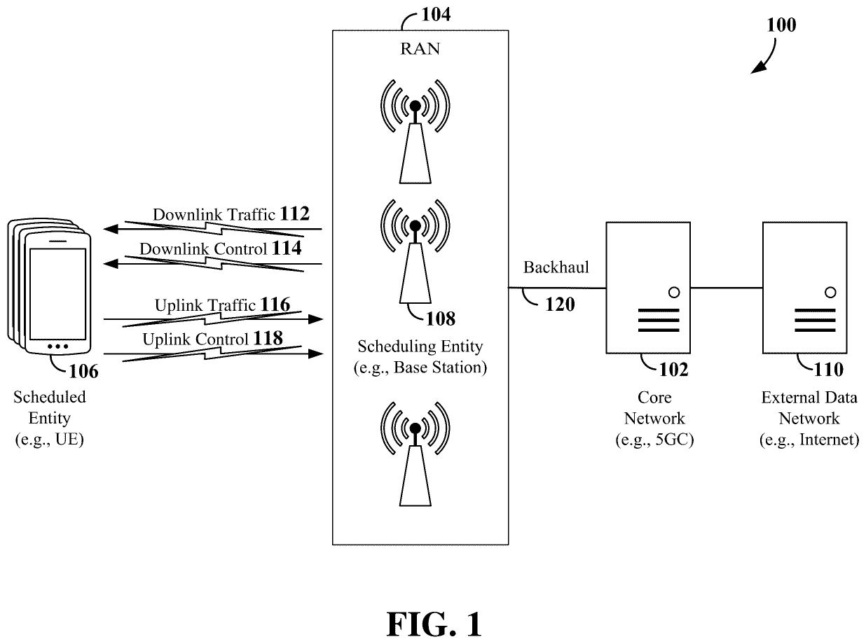

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

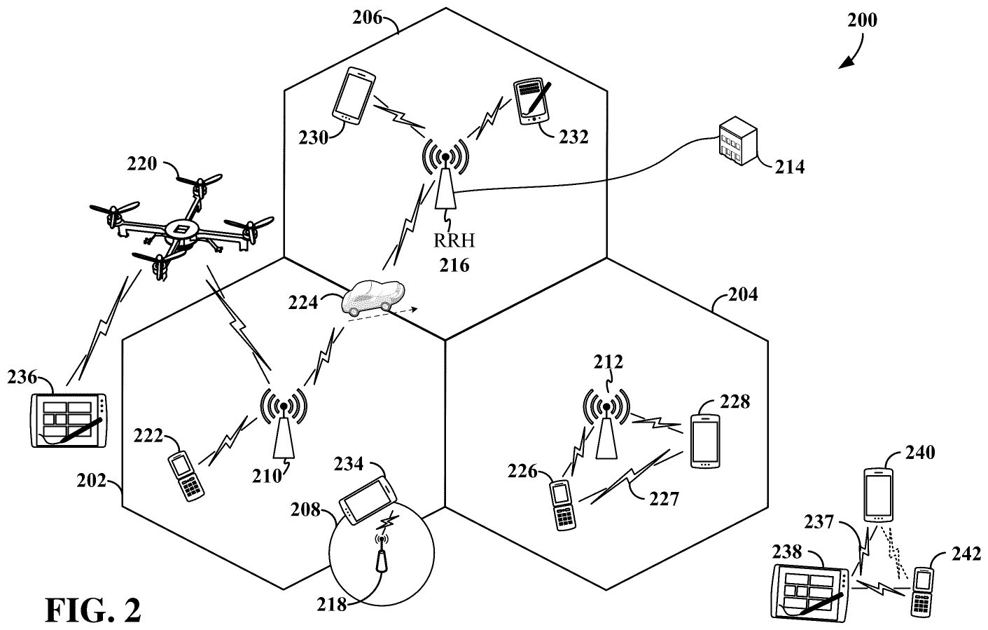

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, the DUs, and the RUs also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

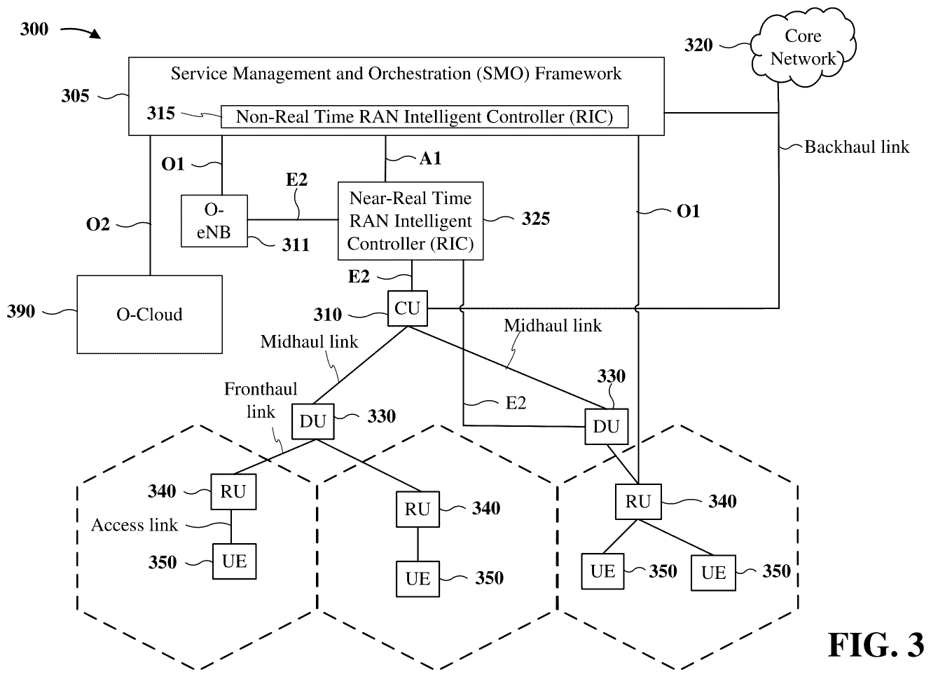

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 350 via one or more radio frequency (RF) access links. In some implementations, the UE 350 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit—User Plane (CU-UP)), control plane functionality (i.e., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the distributed unit (DU) 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 350. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

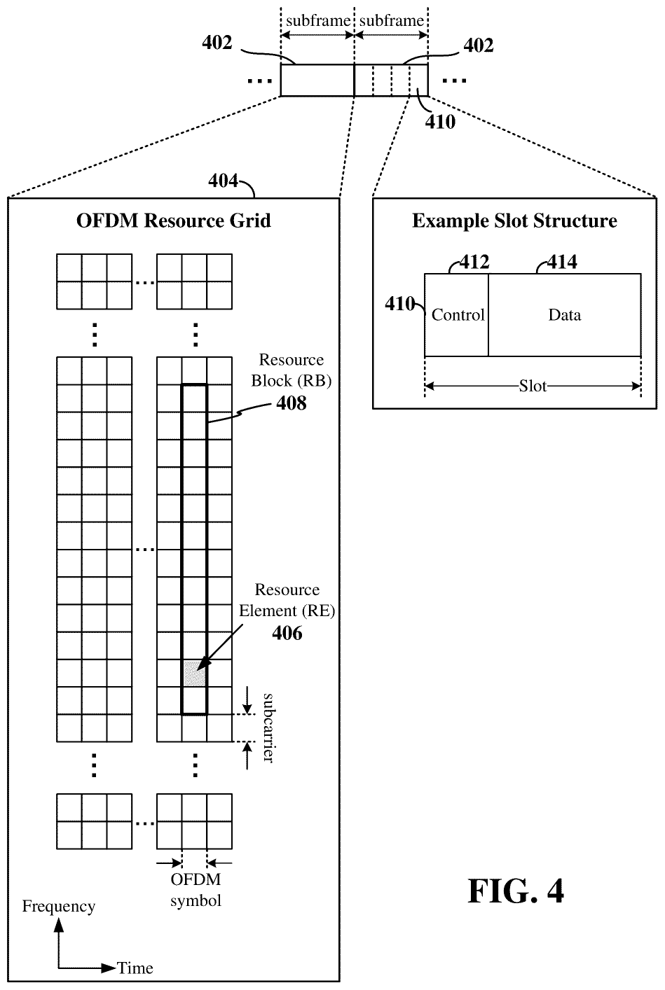

Various aspects of the present disclosure will be described with reference to an OFDM waveform, an example of which is schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an example subframe 402 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely an example, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESETO), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the UE may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-4 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

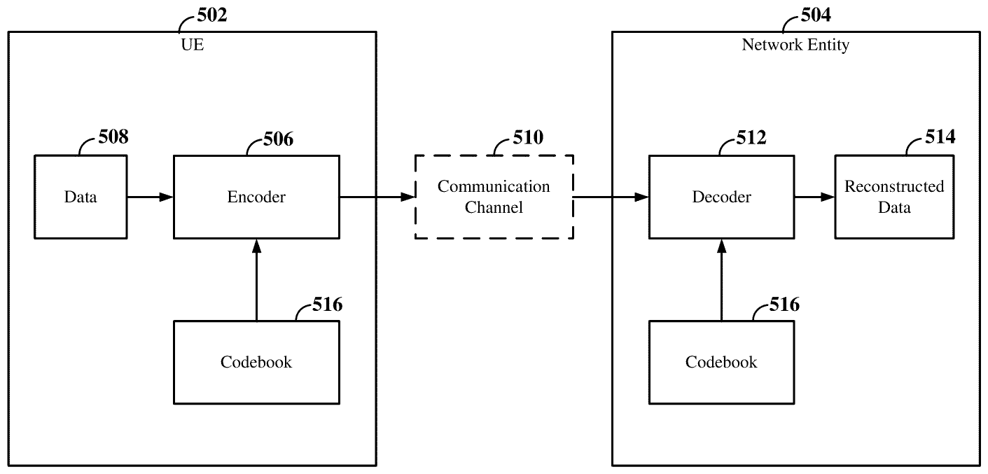

FIG. 5 illustrates an example of a wireless communication system 500 that includes a user equipment (UE) 502 and a network entity (e.g., a gNB) 504 according to some aspects. In some examples, the network entity 504 may correspond to any of the transmitting devices, receiving devices, network entities, base stations, CUs, DUs, RUs, or scheduling entities shown in any of FIGS. 1, 2, 3, 6, and 9. In some examples, the UE 502 may correspond to any of UEs or scheduled entities shown in any of FIGS. 1, 2, 3, 6, and 9.

In the illustrated example, an encoder 506 of the UE 502 encodes data 508 and transmits the encoded data over a communication channel 510 (e.g., a wireless channel) to the network entity 504. A decoder 512 of the network entity 504 decodes the received data to generate reconstructed data 514 that represents the data 508, potentially with a certain amount of error.

In some examples, the data 508 includes information representative of the communication channel 510. For example, the UE 502 may measure CSI-RS signaling (not shown) transmitted by the network entity 504 and generate channel state information (CSI) based on these measurements.

In some examples the CSI may include precoding vectors (e.g., beam direction information, etc.) for different sub-bands. Since the number of precoding vectors may be relatively large, the UE 502 compresses the CSI before sending the CSI to the network entity to reduce signaling overhead. For example, the encoder 506 may use a quantization codebook 516 to generate compressed channel state information feedback (CSF) where the quantization codebook 516 maps the unquantized compressed CSI vector to quantized compressed CSI vector represented by a set of bits. The UE 502 thus sends the compressed CSF represented by a set of bits to the network entity 504 where it is input to the decoder 512. Then, based on knowledge of the quantization codebook 516 used by the encoder 506, the decoder 512 generates a reconstructed CSI (e.g., the reconstructed data 514).

In some examples, machine learning may be used to determine the encoding functionality and the decoding functionality in a communication network. For example, a training operation may be employed whereby the functionality (e.g., algorithms, vectors, etc.) of an encoder and the functionality (e.g., algorithms, vectors, etc.) of a decoder are learned via an iterative machine learning based process.

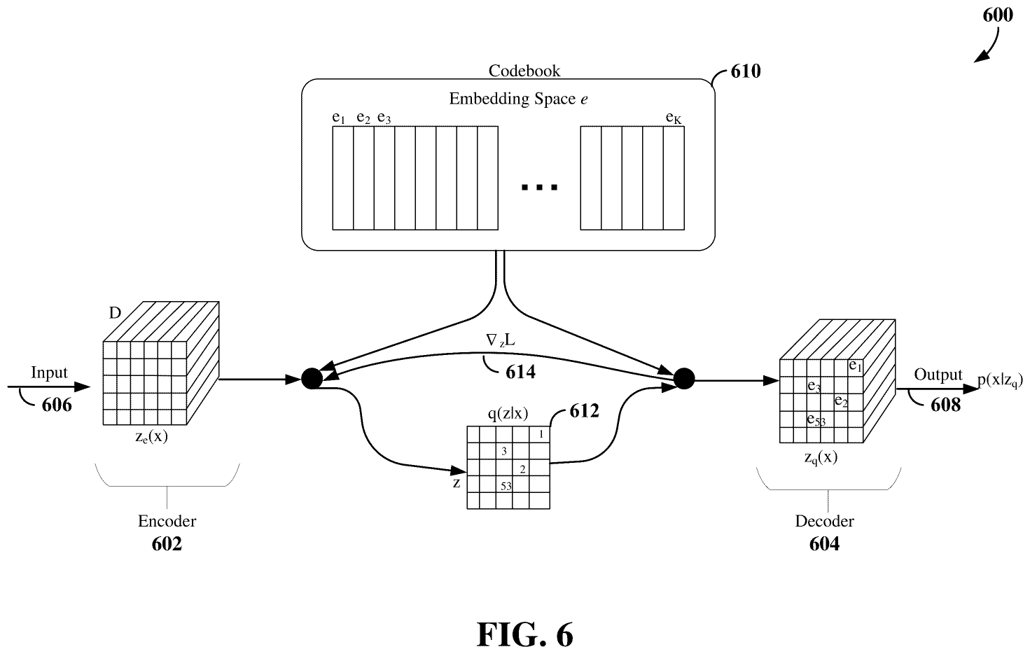

FIG. 6 is a conceptual illustration of an example of a neural network (NN) based machine learning process 600 for an encoder 602 and a decoder 604 as described in van den Oord, A, et al., Neural Discrete Representation Learning, pages 1-10, 31st Conference on Neural Information Processing Systems (NIPS 2017), Long Beach, CA, USA. In some aspects, an NN consists of a layered network of processing nodes that are designed to recognize patterns and thereby recognize underlying relationships in data sets. The encoder 602 encodes an input signal 606 and provides an encoded signal to the decoder 604, and the decoder generates a reconstruction 608 of the input signal 606. In some aspects, the machine learning process 600 involves training autoencoders with discrete latent variables where quantization is based on a shared embedding space e (e.g., codebook 610). In the example of FIG. 6, there are K embedding vectors eᵢ∈R^{D}, i∈1,2, . . . . K. In the machine learning process 600, an input x is passed through the encoder 602 to produce an output zₑ(x) (e.g., a floating point vector). Discrete latent variables z_{q} are then calculated by a nearest neighbor look-up using the shared embedding space e according to Equation 1 (represented by a mapping 612 in FIG. 6).

$$q ( z = {e}_{k} \vert x ) = \{ \begin{matrix}1 & if k = arg {min}_{i} {‖ {z}_{e} ( x ) - {e}_{i} ‖}_{2} \\ 0 & otherwise\end{matrix} \qquad EQUATION 1$$

The input to the decoder 604 is the corresponding embedding vector ex as given in Equation 2.

$${z}_{q} ( x ) = {e}_{k} , where k = arg {min}_{j} {‖ {z}_{e} ( x ) - {e}_{j} ‖}_{2} \qquad EQUATION 2$$

This forward computation pipeline is a regular autoencoder with a particular non-linearity that maps the latent vectors to 1-of-K embedding vectors. The complete set of parameters for the machine learning process 600 correspond to the union of parameters of the encoder 602, the decoder 604, and the embedding space e. In the example of FIG. 6, a single random variable z is used to represent the discrete latent variables. In various examples, a 1D, 2D, or 3D latent feature space may be extracted.

In some examples, the gradient ∇_{z}L 614 may be approximated by copying gradients from the decoder input z_{q}(x) to the encoder output zₑ(x). The output of the encoder zₑ(x) is mapped to the nearest point e₂. The gradient ∇_{z}L 614 will push the encoder 602 to change its output, which may alter the configuration in the next forward pass. During forward computation, the nearest embedding z_{q}(x) is passed to the decoder 604 and, during the backwards pass, the gradient ∇_{z}L 614 is passed unaltered to the encoder 602. Since the output representation of the encoder 602 and the input to the decoder 604 share the same D dimensional space, the gradients contain useful information regarding how the encoder 602 is to change its output to lower the reconstruction loss.

During NN back propagation, the gradient is computed for the decoder 604, the codebook 610, and the encoder 602. Thus, the codebook 610 may be optimized during the back propagation because gradients are computed for the codebook 610, such that the outputs of the encoder 602 may be closer in value to the vectors of the codebook 610, and vice versa.

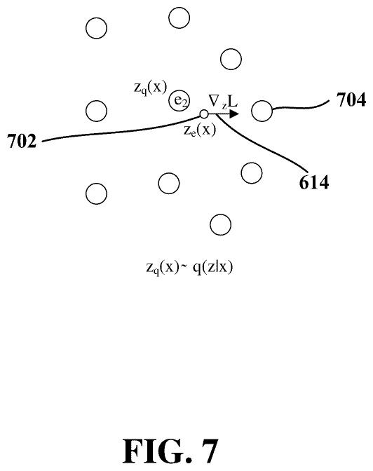

For example, as graphically illustrated in FIG. 7, the gradient ∇_{z}L 614 can push the encoder's output (e.g., zₑ(x) 702) to be discretized differently in the next forward pass, because the assignment in Equation 1 will be different. Thus, for a given encoder output (e.g., zₑ(x) 702), a more accurate quantized vector (one of the larger circles in FIG. 7 such as the circle 704) may be selected.

In some aspects, machine learning may be performed across communication nodes. For example, in one example of cross-node machine learning, an NN is split into two portions including an encoder running on a user equipment (UE) and a decoder running on a network entity (e.g., a gNB). In this case, the encoder output from the UE is transmitted to the network entity as an input to the decoder.

The disclosure relates in some aspects to techniques that enable participating UE vendors and a participating network entity vendor to train encoders for the UEs and a decoder for the network entity. As multiple vendors participate in the training, this training may be referred to as multi-vendor training. In multi-vendor training, each vendor (e.g., a UE vendor, a network entity vendor) has its own server that participates in offline training. The UE vendor servers communicate with network entity vendor servers during the training using server-to-server connections.

In some examples, training is done at both UE vendor servers and the network entity vendor servers. For example, each UE vendor server may train its own NN (e.g., encoder) and each network entity vendor server may train its own NN (e.g., decoder). Once the encoders and decoder are trained, the servers will download the corresponding information to a vendor's respective devices. For example, a server for the network entity may download decoder information to the network entities for the network entity vendor, a first UE server for a first UE vendor may download first encoder information to the UEs for the first vendor, a second UE server for a second UE vendor may download second encoder information to the UEs for the second vendor, and so on.

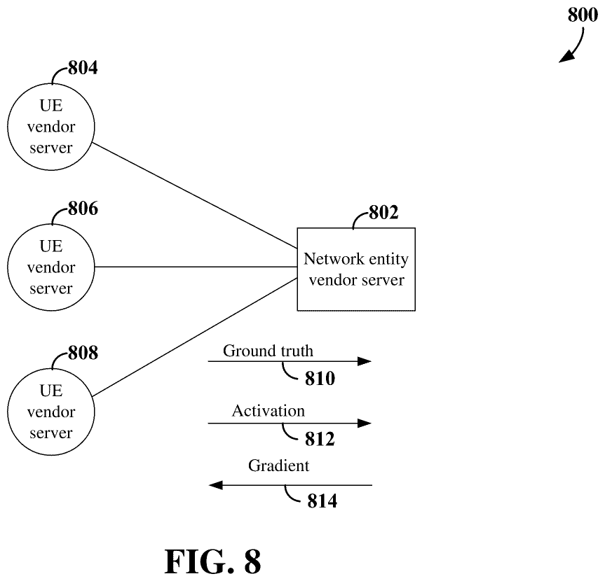

FIG. 8 illustrates an example of a server system 800 that includes at least one network entity vendor server 802 that communicates via server-to-server connections with a first UE vendor server 804 for a first UE vendor, a second UE vendor server 806 for a second UE vendor, and a third UE vendor server 808 for a third UE vendor. These servers cooperate to provide offline training as discussed herein.

As mentioned above, the NN model includes an NN encoder model at each UE vendor server and an NN decoder model at each network entity vendor server. Each NN encoder model (which may simply be referred to as an encoder NN herein) may include a number of NN layers. Similarly, each NN decoder model (which may simply be referred to as a decoder NN herein) may include a number of NN layers.

To facilitate joint training of encoder(s) and decoder(s) for the associated vendors, each of the first UE vendor server 804, the second UE vendor server 806, and the third UE vendor server 808 provides the NN ground truth output 810 for the decoder NN to the network entity vendor server(s) 802. In some examples, the NN ground truth output 810 may correspond to an expected output of the decoder NN for a given defined input. For example, whenever the encoder and decoder training is invoked (e.g., monthly, with each new release of software for a UE, etc.), UEs for each UE vendor may report channel information (e.g., CSI from channel estimates based on CSI-RS measurements) to their corresponding UE vendor server. That is, a first set of UEs for the first UE vendor may report a first set of channel information to the first UE vendor server 804, a second set of UEs for the second UE vendor may report a second set of channel information to the second UE vendor server 806, and so on. Each UE vendor server may then aggregate the channel information received from its UEs and create a corresponding data set (e.g., the expected output of the decoder). Once each UE vendor server has created a data set for the channel information, the UE vendor servers and the network entity vendor server may conduct encoder and decoder training using these data sets (e.g., the NN ground truth outputs 810).

As further illustrated in FIG. 8, each of the first UE vendor server 804, the second UE vendor server 806, and the third UE vendor server 808 provides the NN activation 812 for its corresponding encoder to the network entity vendor server(s) 802. Each network entity vendor server 802 will then use the NN activation 812 as an input to the first layer of its decoder NN. In some examples, the NN activation 812 refers to the output of the last layer of the encoder NN. In some examples, the NN activation 812 (e.g., encoder output) is referred to as a latent vector since, in an autoencoder model (including an encoder and a decoder), compressed information (e.g., the NN activation 812) sent from the encoder to the decoder might not be visible (e.g., to an end user).

As further illustrated in FIG. 8, each network entity vendor server 802 may provide a corresponding NN gradient for each of the encoders of the first UE vendor server 804, the second UE vendor server 806, and the third UE vendor server 808. In some examples, an NN gradient may refer to the change in a weight (e.g., how much a weight is to be changed) for a given change in error (e.g., given the error in the loss function) to improve the reconstruction loss.

Based on the above signaling, the network entity and UE vendor servers may use an iterative NN process to train their respective encoders and decoders. As mentioned above, each UE vendor server sends the ground truth output for its NN decoder to each network entity vendor server. In addition, each UE vendor server sends its output (e.g., NN activation) from the last layer of its encoder NN to the network entity vendor servers. Each network entity vendor server then inputs the received NN activation from each UE to its decoder NN. This enables each network entity vendor server to compute a loss function (e.g., a mean squared error function or some other suitable function) indicative of how accurately the output of the decoder NN matches the corresponding NN ground truth. Based on the loss function (e.g., based on the NN ground truth output provided by each UE vendor server), each network entity vendor server backpropagates NN gradients all the way to the input of its decoder NN. For example, starting at the last NN layer of the NN decoder, gradients are computed NN layer by NN layer to eventually obtain the gradient of the first NN layer (the input) of the NN decoder. Then, the gradients at the input of each network entity vendor server decoder NN are sent to the UE vendor servers. Each UE vendor server then backpropagates the gradients all the way to the input of its corresponding NN encoder. For example, starting at the last NN layer of an NN encoder, gradients are computed NN layer by NN layer to eventually obtain the gradient of the first NN layer (the input) of the NN encoder. The above process is then repeated until desired encoder and decoder models are generated (e.g., the process meets a defined level of convergence). Then UE vendor servers then download their respective encoder models to their respective UEs and the network entity vendor server(s) download the decoder model(s) s to each respective network entity.

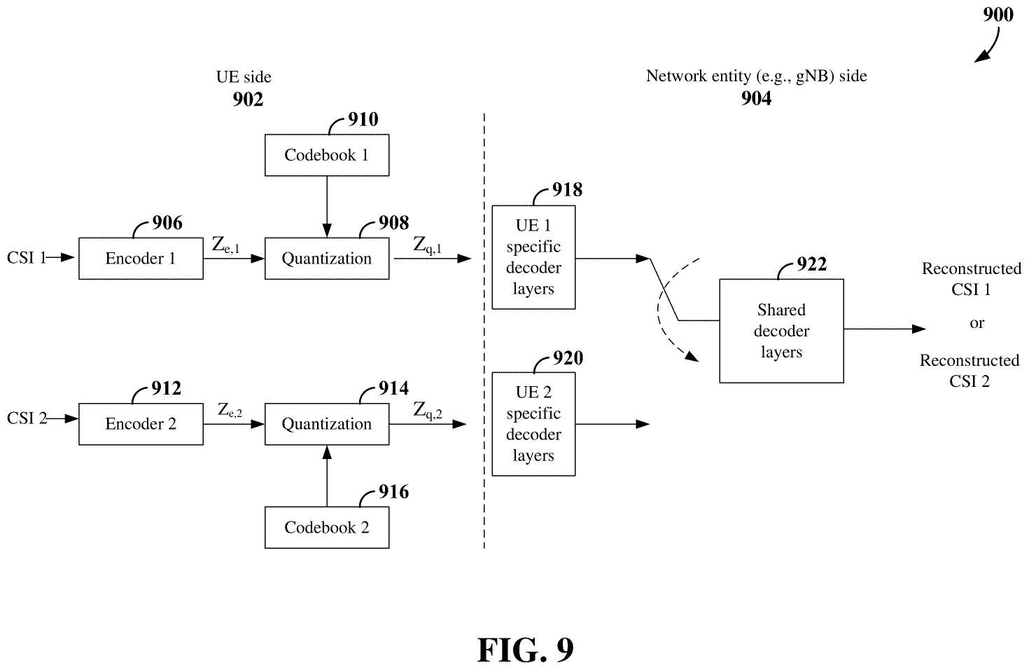

FIG. 9 illustrates an example of UE encoding operations and network entity decoding operations in a communication system 900 where the encoder and decoder NNs are deployed. In this example, two UEs from two different UE vendors send CSF feedback to a network entity of one network entity vendor. A different number of UE vendors and/or network entity vendors may be used in other examples.

FIG. 9 depicts a UE side 902 including components of a first UE and a second UE and a network entity side 904 including components of a network entity. The first UE (UE 1) includes a first encoder 906, a first quantization circuit 908, and a first codebook 910. The second UE (UE 2) includes a second encoder 912, a second quantization circuit 914, and a second codebook 916. The network entity includes a first set of decoder layers 918 that are specific to the first UE (e.g., specific to the encoder used by the first UE), a second set of decoder layers 920 that are specific to the second UE (e.g., specific to the encoder used by the second UE), and a shared set of decoder layers 922 that are common to the first UE and the second UE.

The first encoder 906 encodes a first CSI (CSI 1) to generate a first set of vectors Z_{e,1}. In some aspects, the first set of vectors Z_{e,1} may correspond to latent vectors as discussed herein. The first quantization circuit 908 quantizes the first set of vectors Z_{e,1} (e.g., floating point vectors) based on the first codebook 910 to generate a first set of quantized vectors Z_{q,1} (e.g., one of 16 non-floating point vectors) that are sent to the network entity. For example, the first set of quantized vectors Z_{q,1} may consist of codewords from the first codebook 910 (e.g., indices of the quantized vectors Z_{q,1}).

The second encoder 912 encodes a second CSI (CSI 2) to generate a second set of vectors Z_{e,2}. In some aspects, the second set of vectors Z_{e,2} may correspond to latent vectors as discussed herein. The second quantization circuit 914 quantizes the second set of vectors Z_{e,2} based on the second codebook 916 to generate a second set of quantized vectors Z_{q,2} that are sent to the network entity. For example, the second set of quantized vectors Z_{q,2} may consist of codewords from the second codebook 916.

Thus, as illustrated in FIG. 9, a UE may quantize a latent vector before transmitting it to the network entity such that the latent vector is conveyed using a finite (reduced) number of bits. In various examples, either scalar or vector quantization may be applied to the latent vectors. In some examples, this quantization may be achieved by using codebooks that contain a finite number of scalars or vectors.

The network entity selectively uses the first set of decoder layers 918 or the second set of decoder layers 920 to reconstruct CSI 1 or CSI 2. For example, when the network entity receives the first set of quantized vectors Z_{q,1} from the first UE, the network entity may use the first set of decoder layers 918, the shared decoder layers 922, and the first codebook 910 to process the first set of quantized vectors Z_{q,1} and thereby reconstruct CSI 1. In addition, when the network entity receives the second set of quantized vectors Z_{q,2} from the second UE, the network entity may use the second set of decoder layers 920, the shared decoder layers 922, and the second codebook 916 to process the second set of quantized vectors Z_{q,2} and thereby reconstruct CSI 2. Here, it may be appreciated that the use of the shared decoder layers 922 may improve the efficiency and/or the performance of the network entity (e.g., by reducing the number of decoder layers needed to support the UEs of different UE vendors).

FIG. 9 may be generalized to a system including multiple UEs, where z_{e,i}=the encoder output (e.g., latent vector) from UE i, before quantization, and z_{q,i}=the quantized version of z_{e,i} obtained by using the codebook i. Using a finite (reduced) number of bits representing z_{q,i}, UE i sends z_{q,i} to the network entity. The network entity has each of the codebooks i (e.g., the first codebook 910, the second codebook 916, etc.). Using the codebook i, the network entity processes the received bits representing z_{q,i} to provide the vector z_{q,i}, and inputs z_{q,i} to the decoder. The network entity decoder may consist of shared layers that are common to all the UE's and UE specific layers. When decoding z_{q,1}, the network entity uses UE 1 specific layers and shared decoder layers. When decoding z_{q,2}, the network entity uses UE 2 specific layers and shared decoder layers.

For improved performance, the quantization codebooks may be learned together with the neural networks (NNs) for encoders and decoders, via an end-to-end learning process. The disclosure relates in some aspects to methods for learning latent vector quantization in multi-vendor split learning. These latent vector quantization learning methods may be employed at a UE vendor server and/or a network entity vendor server.

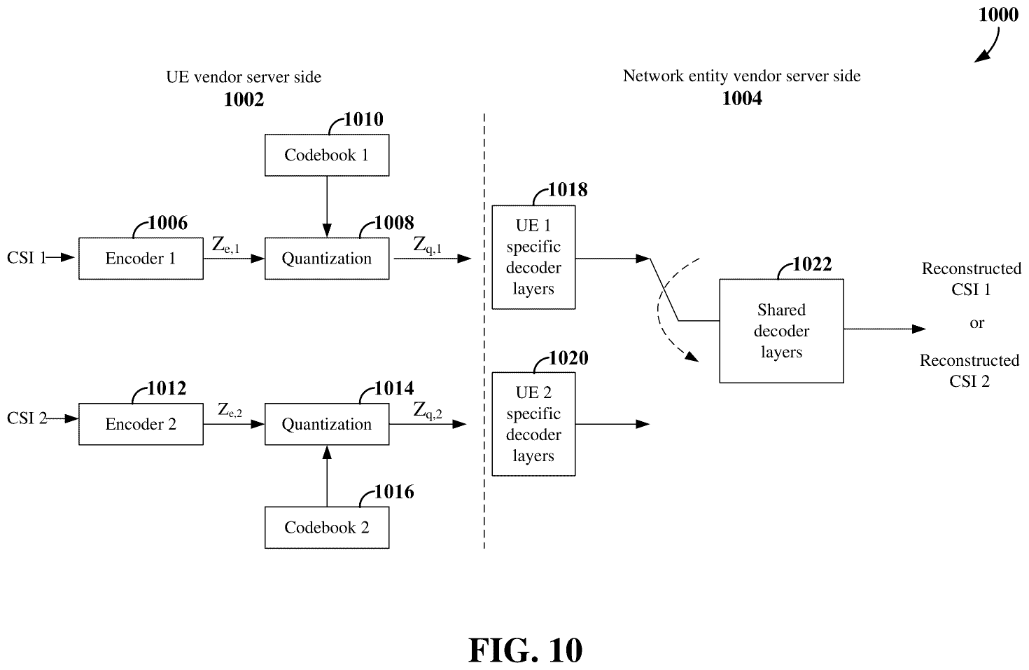

In some examples, a UE vendor server learns quantization codebook information and provides this information to a network entity vendor server. FIG. 10 illustrates an example of encoder and decoder training operations in a communication system 1000. In this example, two UE vendor servers from two different UE vendors send latent vectors (CSF feedback) to a network entity server of one network entity vendor. A different number of UE vendor servers and/or network entity vendor servers may be used in other examples.

FIG. 10 depicts a UE vender server side 1002 including components of a first UE vendor server and a second UE vendor server and a network entity vendor server side 1004 including components of a network entity vendor server. The first UE vendor server (UE server 1) includes a first encoder 1006, a first quantization circuit 1008, and a first codebook 1010. The second UE vendor server (UE server 2) includes a second encoder 1012, a second quantization circuit 1014, and a second codebook 1016. The network entity vendor server includes a first set of decoder layers 1018 that are specific to the first UE vendor server (e.g., specific to the encoder used by the first UE vendor server), a second set of decoder layers 1020 that are specific to the second UE vendor server (e.g., specific to the encoder used by the second UE vendor server), and a shared set of decoder layers 1022 that are common to the first UE vendor server and the second UE vendor server.

The first encoder 1006 encodes a first CSI (CSI 1) to generate a first set of vectors Z_{e,1}. In some aspects, the first set of vectors Z_{e,1} may correspond to latent vectors as discussed herein. The first quantization circuit 1008 quantizes the first set of vectors Z_{e,1} based on the first codebook 1010 to generate a first set of quantized vectors Z_{q,1} that are sent to the network entity vendor server. For example, the first set of quantized vectors Z_{q,1} may consist of codewords from the first codebook 1010. Of note, in contrast with the example of FIG. 9, the first UE vendor server does not convert the first set of quantized vectors Z_{q,1} to a finite (reduced) number of bits. Instead, the first UE vendor server sends the first set of quantized vectors Z_{q,1} as is to the network entity vendor server, such that the need for the network entity vendor server to know the first codebook 1010 is eliminated.

The second encoder 1012 encodes a second CSI (CSI 2) to generate a second set of vectors Z_{e,2}. In some aspects, the second set of vectors Z_{e,2} may correspond to latent vectors as discussed herein. The second quantization circuit 1014 quantizes the second set of vectors Z_{e,2} based on the second codebook 1016 to generate a second set of quantized vectors Z_{q,2} that are sent to the network entity vendor server. For example, the second set of quantized vectors Z_{q,2} may consist of codewords from the second codebook 1016. Of note, in contrast with the example of FIG. 9, the second UE vendor server does not convert the second set of quantized vectors Z_{q,2} to a finite (reduced) number of bits. Instead, the second UE vendor server sends the second set of quantized vectors Z_{q,2} as is to the network entity vendor server, such that the need for the network entity vendor server to know the second codebook 1016.

The network entity vendor server selectively uses the first set of decoder layers 1018 or the second set of decoder layers 1020 to reconstruct CSI 1 or CSI 2. For example, when the network entity vendor server receives the first set of quantized vectors Z_{q,1} from the first UE vendor server, the network entity vendor server may use the first set of decoder layers 1018 and the shared decoder layers 1022 to process the first set of quantized vectors Z_{q,1} and thereby reconstruct CSI 1. In addition, when the network entity vendor server receives the second set of quantized vectors Z_{q,2} from the second UE vendor server, the network entity vendor server may use the second set of decoder layers 1020 and the shared decoder layers 1022 to process the second set of quantized vectors Z_{q,2} and thereby reconstruct CSI 2.

Prior to the training sessions, the network entity vendors and the UE vendors agree upon a set of quantization schemes (e.g., scalar quantization, vector quantization, etc.). In this way, different UE vendors may elect to use different quantization schemes, provided the schemes are in the agreed upon set.

During forward pass during training, using codebook i, UE vendor server i applies its selected quantization to z_{e,i} to obtain z_{q,i}. The network entity vendor server receives z_{q,i} from the UE vendor server i, and inputs it to its decoder. The network entity server will perform backpropagation to compute and send the corresponding gradients at the input to its decoder to each UE vendor server i. UE vendor server i will backpropagate the corresponding gradients received from the network entity server and the gradients for the unquantized encoder output based on the first quantization loss to compute the gradients for its encoder layers. Also, the gradients for the codebook are calculated based on the second quantization loss. This process (forward pass, back propagation) repeats until the desired encoder model, decoder model, and codebook are obtained (i.e., the training reaches a desired convergence).

After the training reaches convergence, each UE vendor server provides the learned codebook and the chosen quantization scheme to the network entity vendor server. Of note, in this case, the network entity vendor server does not need to know the codebooks used by the UE vendor servers during the training, since z_{q,i} is sent to the network entity vendor server, as is, without converting it to a set of bits using the codeword indices for codebook i.

In some examples, a network entity vendor server learns quantization codebook information and provides this information to a UE vendor server. Thus, in this case, the network entity vendor server performs quantization during the training.

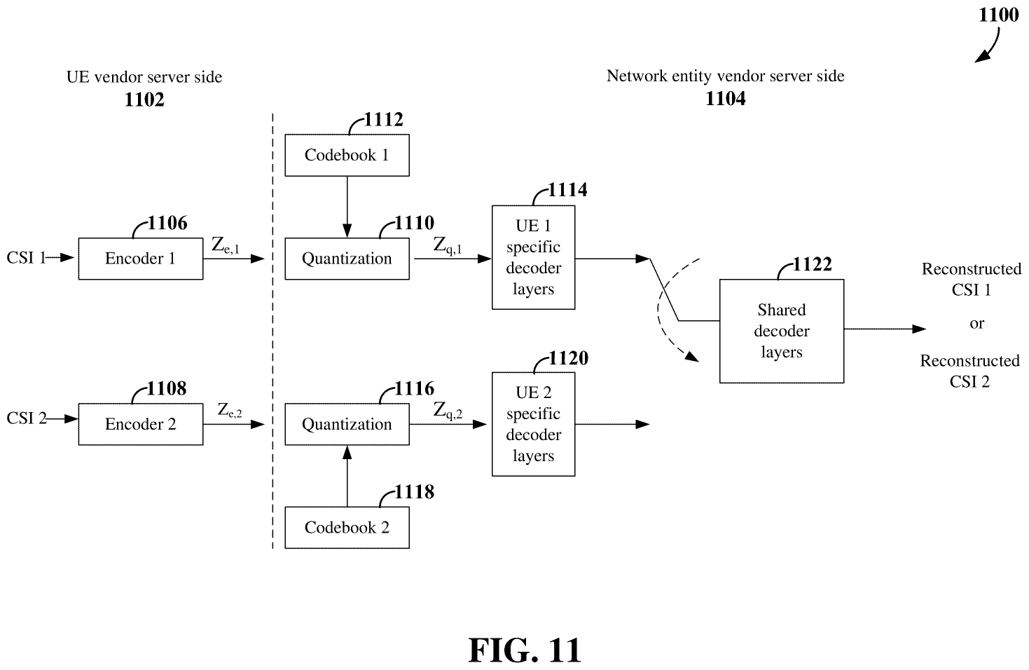

FIG. 11 illustrates an example of encoder and decoder training operations in a communication system 1100. In this example, two UE vendor servers from two different UE vendors send (CSF feedback) to a network entity server of one network entity vendor. A different number of UE vendor servers and/or network entity vendor servers may be used in other examples.

FIG. 11 depicts a UE vender server side 1102 including components of a first UE vendor server and a second UE vendor server and a network entity vendor server side 1104 including components of a network entity vendor server. The first UE vendor server (UE server 1) includes a first encoder 1106. The second UE vendor server (UE server 2) includes a second encoder 1108. The network entity vendor server includes a first quantization circuit 1110, a first codebook 1112, and a first set of decoder layers 1114 that are specific to the first UE vendor server (e.g., specific to the encoder used by the first UE vendor server). The network entity vendor server also includes a second quantization circuit 1116, a second codebook 1118, and a second set of decoder layers 1120 that are specific to the second UE vendor server (e.g., specific to the encoder used by the second UE vendor server). In addition, the network entity vendor server includes a shared set of decoder layers 1122 that are common to the first UE vendor server and the second UE vendor server.

The first encoder 1106 encodes a first CSI (CSI 1) to generate a first set of vectors Z_{e,1}. In some aspects, the first set of vectors Z_{e,1} may correspond to latent vectors as discussed herein. The first UE vendor server sends the first set of vectors Z_{e,1} as is to the network entity vendor server. At the network entity vendor server, the first quantization circuit 1110 quantizes the first set of vectors Z_{e,1} based on the first codebook 1112 to generate a first set of quantized vectors Z_{q,1} that are sent to the network entity server's decoder. For example, the first set of quantized vectors Z_{q,1} may consist of codewords from the first codebook 1112.

The second encoder 1108 encodes a second CSI (CSI 2) to generate a second set of vectors Z_{e,2}. In some aspects, the second set of vectors Z_{e,2} may correspond to latent vectors as discussed herein. The second UE vendor server sends the second set of vectors Z_{e,2} as is to the network entity vendor server. At the network entity vendor server, the second quantization circuit 1116 quantizes the second set of vectors Z_{e,2} based on the second codebook 1118 to generate a second set of quantized vectors Z_{q,2} that are sent to the network entity server's decoder. For example, the second set of quantized vectors Z_{q,2} may consist of codewords from the second codebook 1118.

The network entity vendor server selectively uses the first set of decoder layers 1114 or the second set of decoder layers 1120 to reconstruct CSI 1 or CSI 2. For example, when the network entity vendor server receives the first set of vectors Z_{e,1} from the first UE vendor server, the first quantization circuit 1110 quantizes the first set of vectors Z_{e,1} based on the first codebook 1112 to generate a first set of quantized vectors Z_{q,1}. The network entity vendor server may then use the first set of decoder layers 1114 and the shared decoder layers 1122 to process the first set of quantized vectors Z_{q,1} and thereby reconstruct CSI 1. In addition, when the network entity vendor server receives the second set of vectors Z_{e,2} from the second UE vendor server, the second quantization circuit 1116 quantizes the second set of vectors Z_{e,1} based on the second codebook 1118 to generate a second set of quantized vectors Z_{q,2}. The network entity vendor server may then use the second set of decoder layers 1120 and the shared decoder layers 1122 to process the second set of quantized vectors Z_{q,2} and thereby reconstruct CSI 2.

Prior to the training sessions, the network entity vendors and the UE vendors agree upon a set of quantization schemes (e.g., scalar quantization, vector quantization, etc.). In addition, prior to the training sessions, the network entity vendor may choose a quantization scheme at its discretion. In this case, the UE vendor server does not perform quantization during the training.

During forward pass during training, the network entity vendor server receives z_{e,i} from the UE vendor server i. Using codebook i, the network entity vendor server i applies the quantization to z_{e,i} to obtain z_{q,i}.

After the training, a network entity vendor server provides the learned codebook and the chosen quantization scheme to the UE vendor server. Of note, in this example, the UE vendor servers do not need to know the codebooks used by the network entity vendor servers during the training.

In some examples, a UE vendor may indicate to a network entity vendor one or more preferences for a codebook structure and/or quantization. For example, a UE vendor may specify a particular quantization and/or a set of preferred codebook structures for the network entity vendor to use.

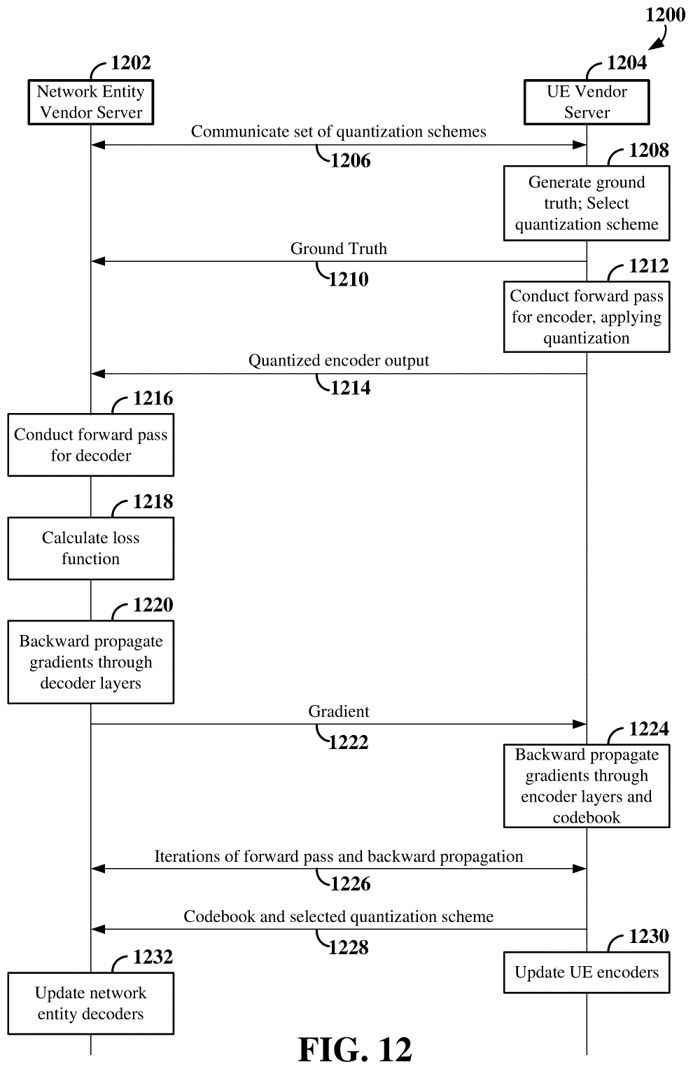

FIG. 12 is a signaling diagram illustrating an example of training-related signaling 1200 in a communication system including a first server 1202 (a network entity vendor server) and a second server 1204 (a UE vendor server). As discussed above, encoder and decoder training may involve multiple UE vendor servers and multiple network entity servers. To reduce the complexity of FIG. 12, an example of the operations between only two servers is described. It should be appreciated that similar operations may be performed with other servers (e.g., a network entity vendor server may communicate with multiple UE vendor servers using operations similar to those described in FIG. 12). In some examples, the first server 1202 may correspond to any of the any of the servers shown in any of FIGS. 1, 2, 3, 8, 10, 13, and 17. In some examples, the second server 1204 may correspond to any of the servers shown in any of FIGS. 1, 2, 3, 8, 10, 13, and 14.

At 1206 of FIG. 12, the first server 1202 and the second server 1204 communicate to identify a set of quantization schemes (quantizing schemes) that may be used for an encoder and decoder training operation. For example, the identified set may include (e.g., comprises) one or more types of scalar quantization, one or more types of vector quantization, and/or one or more types of some other form of quantization.

At 1208, the second server 1204 generates a ground truth for the encoder and decoder training. For example, the second server 1204 may determine an expected decoder output based on channel state information that the second server 1204 receives from a set of UEs that are deployed by the UE vendor that operates the second server 1204. Also at 1208, the second server 1204 may select one quantization scheme from the set of quantization schemes to use for the encoder and decoder training.

At 1210, the second server 1204 may transmit the ground truth (e.g., the expected decoder output) to the first server 1202.

At 1212, the second server 1204 may conduct a forward pass operation for its encoder NN by encoding a known data set. In addition, the second server 1204 may use the selected quantization scheme to quantize the output of encoder NN.

At 1214, the second server 1204 transmits the output of the encoder NN to the first server 1202. As discussed here, this may involve transmitting a quantized encoder output signal to the first server 1202.

At 1216, the first server 1202 may conduct a forward pass operation for its decoder NN by decoding the encoder output received from the second server 1204 at 1214.

At 1218, the first server 1202 calculates a loss function based on the ground truth received at 1210 and the output of the last layer of the decoder NN. In some examples, the loss function is indicative of the error in a reconstructed signal (e.g., a reconstructed CSI) output by the decoder NN relative to the ground truth. In some examples, the loss function may be a mean square error function. Other forms of loss functions may be used in other examples.

At 1220, the first server 1202 backward propagates gradients through the layers of the decoder NN. For example, the first server 1202 may calculate a first gradient based on the loss function for the last layer of the decoder NN. This, in turn, may allow a gradient to be calculated for the second to last layer of the decoder NN. This process continues layer-by-layer until a gradient is calculated for the first layer of the decoder NN.

At 1222, the first server 1202 transmits the gradient for the first layer of the decoder NN to the second server 1204.

At 1224, the second server 1204 backward propagates gradients through the layers of the encoder NN. For example, the second server 1204 may apply the gradient received at 1222, and the gradients for the unquantized encoder output calculated based on the first quantization loss to calculate the gradients for the last layer of the encoder NN. This, in turn, may allow a gradient to be calculated for the second to last layer of the encoder NN. This process continues layer-by-layer until a gradient is calculated for the first layer of the encoder NN. The backward propagation is also applied to the codewords in the codebook based on the second quantization loss (e.g., as discussed above in conjunction with FIG. 6). Finally, the parameters of the encoder NN, the parameters of the decoder NN, and the codewords in the codebook are updated once, using all the gradients calculated from the backpropagation.

This completes one iteration of the encoder decoder learning whereby the parameters for all layers of the encoder NN and the decoder NN and the codewords in the codebook have been updated one time.

At 1226, the first server 1202 and the second server 1204 perform multiple iterations of the encoder and decoder training operation. For example, the operations of 1212-1224 may be repeated until satisfactory encoder and decoder models are generated (e.g., the loss function generates an error value that is below an error threshold, or reaches convergence.).

At 1228, once the training completes, the second server 1204 transmits codebook information indicative of the updated codebook to the first server 1202. In addition, the second server 1204 transmits an indication of the quantization scheme selected at 1208 to the first server 1202.

At 1230, the second server 1204 updates the encoders of its associated UEs based on the trained encoder NN, the updated codebook, and the selected quantization scheme. For example, the second server 1204 may send a message to each UE indicating that the UE is to use a particular set of encoder parameters, a particular codebook, and a particular type of quantization for encoding operations when communicating with a network entity that is deployed by a network entity vendor that operates the first server 1202.

At 1232, the first server 1202 updates the decoders of its associated network entities based on the trained decoder NN, the updated codebook, and the selected quantization scheme. For example, the first server 1202 may send a message to each network entity indicating that the network entity is to use a particular set of decoder parameters, a particular codebook, and a particular type of quantization for decoding operations when communicating with a UE that is deployed by a UE vendor that operates the second server 1204.

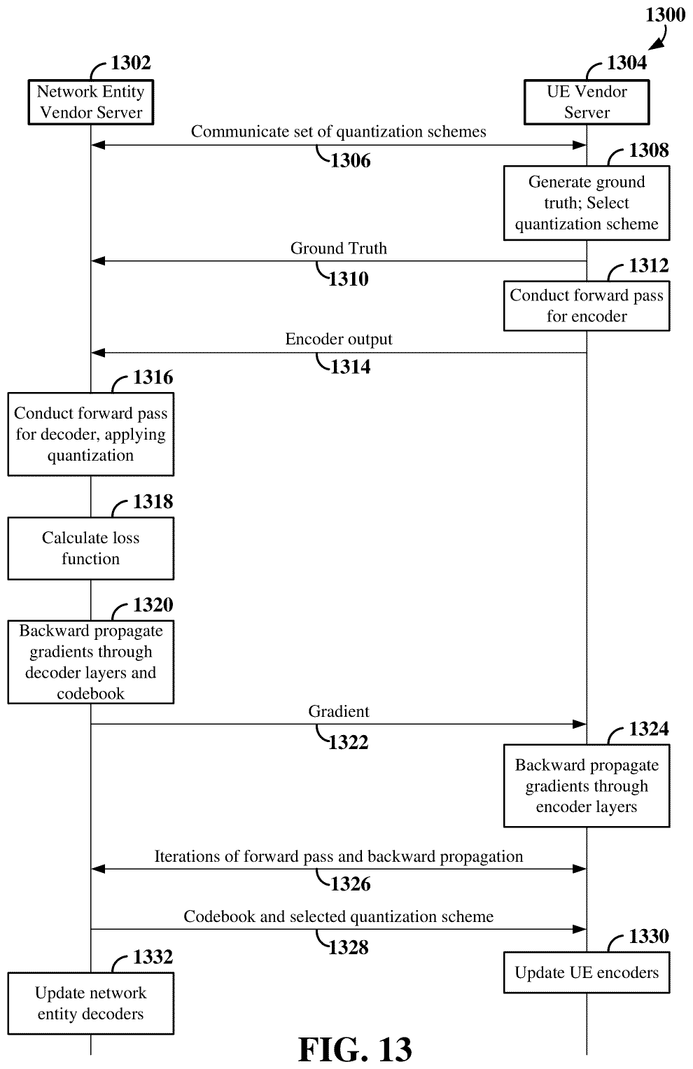

FIG. 13 is a signaling diagram illustrating another example of training-related signaling 1300 in a communication system including a first server 1302 (a network entity vendor server) and a second server 1304 (a UE vendor server). As discussed above, encoder and decoder training may involve multiple UE vendor servers and multiple network entity servers. To reduce the complexity of FIG. 13, an example of the operations between only two servers is described. It should be appreciated that similar operations may be performed with other servers (e.g., a network entity vendor server may communicate with multiple UE vendor servers using operations similar to those described in FIG. 13). In some examples, the first server 1302 may correspond to any of the any of the servers shown in any of FIGS. 1, 2, 3, 8, 10, 12, and 17. In some examples, the second server 1304 may correspond to any of the servers shown in any of FIGS. 1, 2, 3, 8, 10, 12, and 14.

At 1306 of FIG. 13, the first server 1302 and the second server 1304 communicate to identify a set of quantization schemes that may be used for an encoder and decoder training operation. For example, the identified set may include one or more types of scalar quantization, one or more types of vector quantization, and/or one or more types of some other form of quantization.

At 1308, the second server 1304 generates a ground truth for the encoder and decoder training. For example, the second server 1304 may determine an expected decoder output based on channel state information that the second server 1304 receives from a set of UEs that are deployed by the UE vendor that operates the second server 1304.

At 1310, the second server 1304 may transmit the ground truth (e.g., the expected decoder output) to the first server 1302.

At 1312, the second server 1304 may conduct a forward pass operation for its encoder NN by encoding a known data set.

At 1314, the second server 1304 transmits the output of the encoder NN to the first server 1302. As discussed here, this may involve transmitting an unquantized encoder output signal to the first server 1302.

At 1316, the first server 1302 may conduct a forward pass operation for its decoder NN by decoding the encoder output received from the second server 1304 at 1314. In this example, the second server 1304 may select one quantization scheme from the set of quantization schemes to use for the encoder and decoder training. As discussed herein, the first server 1302 may use the selected quantization scheme and a codeword to quantize the encoder output received from the second server 1304 prior to applying the encoder output to the input of the decoder NN.

At 1318, the first server 1302 calculates a loss function based on the ground truth received at 1310 and the output of the last layer of the decoder NN. In some examples, the loss function is indicative of the error in a reconstructed signal (e.g., a reconstructed CSI) output by the decoder NN relative to the ground truth, and the first quantization loss for the unquantized encoder output. In some examples, the loss function may be a mean square error function. Other forms of loss functions may be used in other examples.

At 1320, the first server 1302 backward propagates gradients through the layers of the decoder NN. For example, the first server 1302 may calculate a first gradient based on the loss function for the last layer of the decoder NN. This, in turn, may allow a gradient to be calculated for the second to last layer of the decoder NN. This process continues layer-by-layer until a gradient is calculated for the first layer of the decoder NN. The backward propagation is also applied to the codewords in the codebook, based on the second quantization loss (e.g., as discussed above in conjunction with FIG. 6).

At 1322, the first server 1302 transmits the gradient for the first layer of the decoder NN to the second server 1304.

At 1324, the second server 1304 backward propagates gradients through the layers of the encoder NN. For example, the second server 1304 may apply the gradient received at 1322 to calculate the gradients for the last layer of the encoder NN. This, in turn, may allow a gradient to be calculated for the second to last layer of the encoder NN. This process continues layer-by-layer until a gradient is calculated for the first layer of the encoder NN. Finally, the parameters of the encoder NN, the parameters of the decoder NN, and the codewords in the codebook are updated once, using the gradients calculated from the backpropagation.

This completes one iteration of the encoder decoder learning whereby the parameters for all layers of the encoder NN and the decoder NN, and the codewords in the codebook have been updated one time.

At 1326, the first server 1302 and the second server 1304 perform multiple iterations of the encoder and decoder training operation. For example, the operations of 1312-1324 may be repeated until satisfactory encoder and decoder models are generated (e.g., the loss function generates an error value that is below an error threshold, or reaches convergence.).

At 1328, once the training completes, the first server 1302 transmits codebook information indicative of the updated codebook to the second server 1304. In addition, the first server 1302 transmits an indication of the quantization scheme selected at 1308 to the second server 1304.

At 1330, the second server 1304 updates the encoders of its associated UEs based on the trained encoder NN, the updated codebook, and the selected quantization scheme. For example, the second server 1304 may send a message to each UE indicating that the UE is to use a particular set of encoder parameters, a particular codebook, and a particular type of quantization for encoding operations when communicating with a network entity that is deployed by a network entity vendor that operates the first server 1302.

At 1332, the first server 1302 updates the decoders of its associated network entities based on the trained decoder NN, the updated codebook, and the selected quantization scheme. For example, the first server 1302 may send a message to each network entity indicating that the network entity is to use a particular set of decoder parameters, a particular codebook, and a particular type of quantization for decoding operations when communicating with a UE that is deployed by a UE vendor that operates the second server 1304.

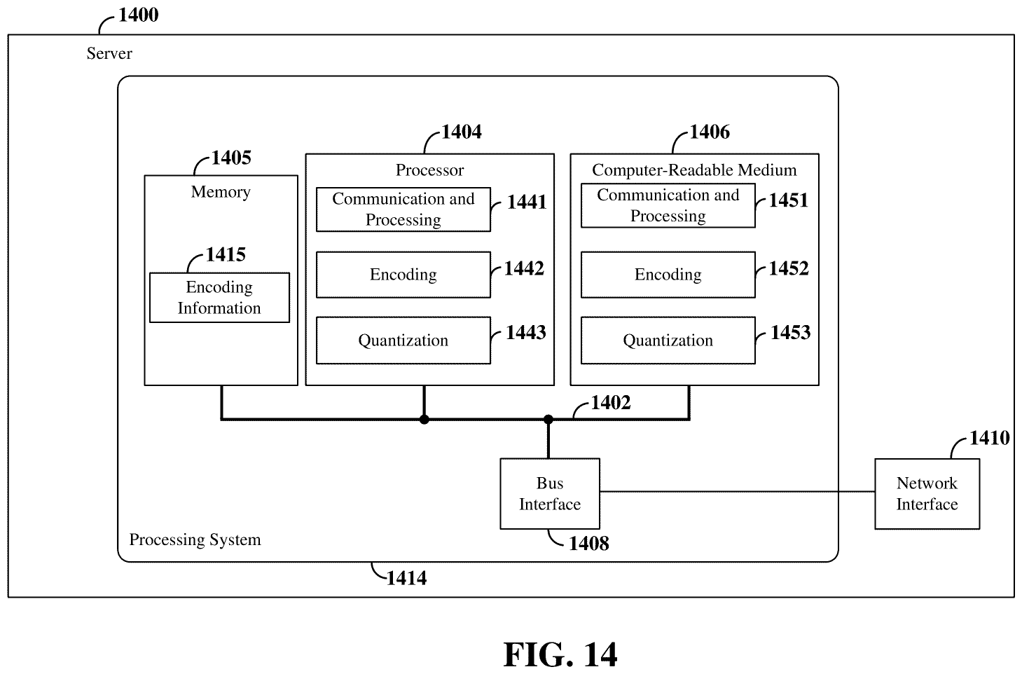

FIG. 14 is a block diagram illustrating an example of a hardware implementation for a server 1400 employing a processing system 1414. In some examples, the server 1400 may be a device configured to communicate with one or more of the UEs or scheduled entities as discussed in any one or more of FIGS. 1-13. In some implementations, the server 1400 may correspond to any of the servers shown in any of FIGS. 1, 2, 3, 8, 10, 12, and 13. In some examples, the server 1400 may be implemented using one or more server entities (e.g., in a cloud-based server implementation).

In accordance with various aspects of the disclosure, an element, or any portion of an element, or any combination of elements may be implemented with the processing system 1414. The processing system 1414 may include one or more processors 1404. Examples of processors 1404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the server 1400 may be configured to perform any one or more of the functions described herein. That is, the processor 1404, as utilized in a server 1400, may be used to implement any one or more of the processes and procedures described herein.

In this example, the processing system 1414 may be implemented with a bus architecture, represented generally by the bus 1402. The bus 1402 may include any number of interconnecting buses and bridges depending on the specific application of the processing system 1414 and the overall design constraints. The bus 1402 communicatively couples together various circuits including one or more processors (represented generally by the processor 1404), a memory 1405, and computer-readable media (represented generally by the computer-readable medium 1406). The bus 1402 may also link various other circuits such as timing sources, peripherals, voltage regulators, and power management circuits, which are well known in the art, and therefore, will not be described any further. A bus interface 1408 provides an interface between the bus 1402 and a network interface 1410. The network interface 1410 provides a communication interface or means for communicating with various other apparatuses and devices over a wired and/or wireless transmission medium. In some examples, the network interface 1410 provides a means for establishing communication with UEs operating in at least one radio access network.

The processor 1404 is responsible for managing the bus 1402 and general processing, including the execution of software stored on the computer-readable medium 1406. The software, when executed by the processor 1404, causes the processing system 1414 to perform the various functions described below for any particular apparatus. The computer-readable medium 1406 and the memory 1405 may also be used for storing data that is manipulated by the processor 1404 when executing software. For example, the memory 1405 may store encoding information 1415 (e.g., quantization scheme information) used by the processor 1404 for the communication operations described herein.

One or more processors 1404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1406.

The computer-readable medium 1406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1406 may reside in the processing system 1414, external to the processing system 1414, or distributed across multiple entities including the processing system 1414. The computer-readable medium 1406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

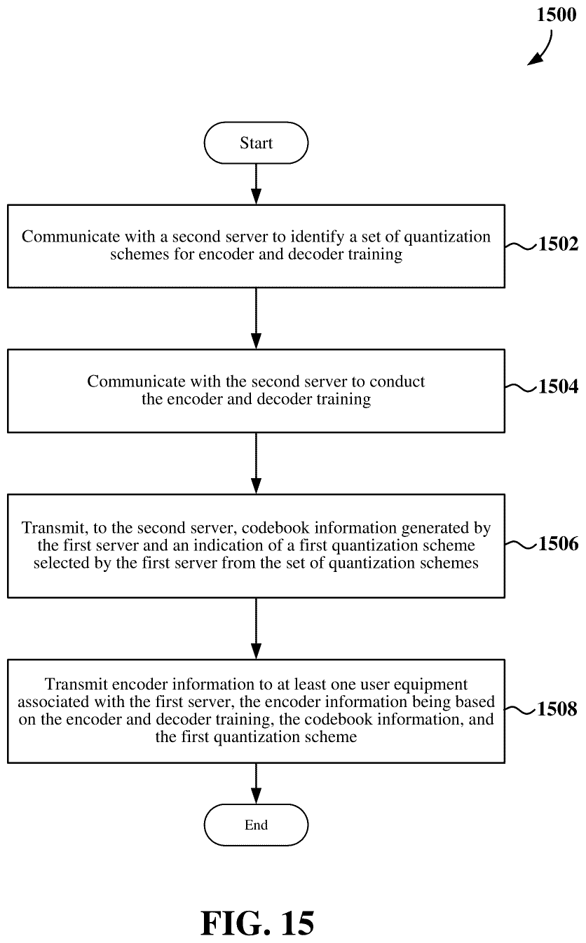

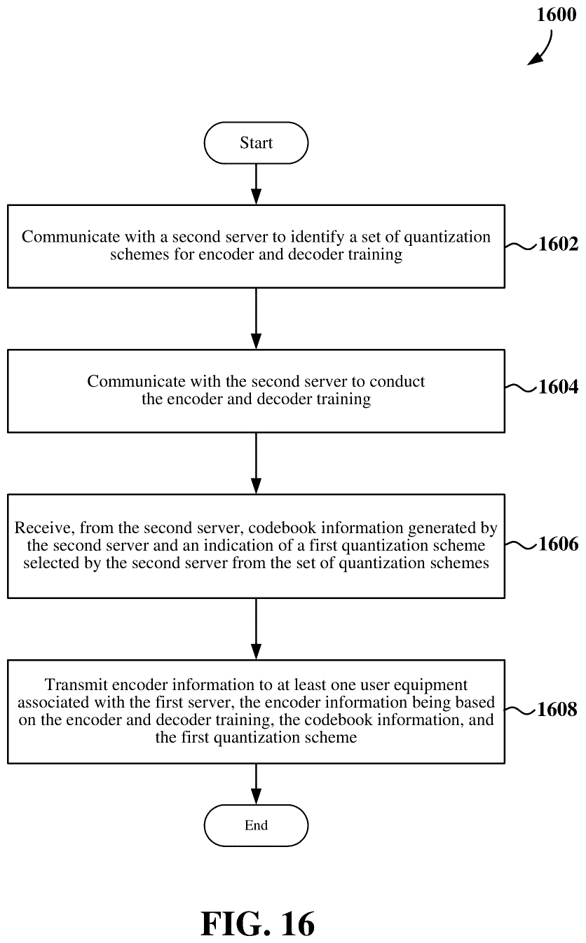

The server 1400 may be configured to perform any one or more of the operations described herein (e.g., as described above in conjunction with FIGS. 1-13 and as described below in conjunction with FIGS. 15 and 16). In some aspects of the disclosure, the processor 1404, as utilized in the server 1400, may include circuitry configured for various functions.

The processor 1404 may include communication and processing circuitry 1441. The communication and processing circuitry 1441 may be configured to communicate with another server and/or a UE. The communication and processing circuitry 1441 may include one or more hardware components that provide the physical structure that performs various processes related to wired and/or wireless communication (e.g., signal reception and/or signal transmission) as described herein. The communication and processing circuitry 1441 may further include one or more hardware components that provide the physical structure that performs various processes related to signal processing (e.g., processing a received signal and/or processing a signal for transmission) as described herein. In some examples, the communication and processing circuitry 1441 may include two or more transmit/receive chains (e.g., one chain to communicate with a UE and another chain to communicate with a server). The communication and processing circuitry 1441 may further be configured to execute communication and processing software 1451 included on the computer-readable medium 1406 to implement one or more functions described herein.

In some implementations where the communication involves receiving information, the communication and processing circuitry 1441 may obtain information from a component of the server 1400 (e.g., from the network interface 1410 that receives the information via signaling suitable for the applicable communication medium), process (e.g., decode) the information, and output the processed information. For example, the communication and processing circuitry 1441 may output the information to another component of the processor 1404, to the memory 1405, or to the bus interface 1408. In some examples, the communication and processing circuitry 1441 may receive one or more of signals, messages, other information, or any combination thereof. In some examples, the communication and processing circuitry 1441 may receive information via one or more channels. In some examples, the communication and processing circuitry 1441 may receive one or more of signals, messages, feedback, other information, or any combination thereof. In some examples, the communication and processing circuitry 1441 may include functionality for a means for receiving. In some examples, the communication and processing circuitry 1441 may include functionality for a means for decoding.

In some implementations where the communication involves sending (e.g., transmitting) information, the communication and processing circuitry 1441 may obtain information (e.g., from another component of the processor 1404, the memory 1405, or the bus interface 1408), process (e.g., encode) the information, and output the processed information. For example, the communication and processing circuitry 1441 may output the information to the network interface 1410 (e.g., that transmits the information via signaling suitable for the applicable communication medium). In some examples, the communication and processing circuitry 1441 may send one or more of signals, messages, other information, or any combination thereof. In some examples, the communication and processing circuitry 1441 may send information via one or more channels. In some examples, the communication and processing circuitry 1441 may send one or more of signals, messages, feedback, other information, or any combination thereof. In some examples, the communication and processing circuitry 1441 may include functionality for a means for sending (e.g., a means for transmitting). In some examples, the communication and processing circuitry 1441 may include functionality for a means for encoding.

The processor 1404 may include encoding circuitry 1442 configured to perform encoding-related operations as discussed herein (e.g., one or more of the operations described above in conjunction with FIGS. 6-13). The encoding circuitry 1442 may be configured to execute encoding software 1452 included on the computer-readable medium 1406 to implement one or more functions described herein.

The encoding circuitry 1442 may include functionality for a means for communicating with another server (e.g., as described above in conjunction with FIGS. 6-13). For example, the encoding circuitry 1442 may cooperate with the communication and processing circuitry 1441 to communicate with a server associated with a gNB vendor to conduct NN-based encoder and decoder training (e.g., receive parameters to be used for training an encoder NN and send parameters generated by the encoder NN during the training).

The encoding circuitry 1442 may include functionality for a means for transmitting information (e.g., as described above in conjunction with FIGS. 6-13). For example, the encoding circuitry 1442 may cooperate with the communication and processing circuitry 1441 to transmit encoder information generated by NN-based encoder training to a set of UEs associated with the server 1400. As another example, the encoding circuitry 1442 may cooperate with the communication and processing circuitry 1441 to transmit codebook information generated by NN-based encoder training to a server associated with a gNB vendor.

The processor 1404 may include quantization circuitry 1443 configured to perform quantization-related operations as discussed herein (e.g., one or more of the operations described above in conjunction with FIGS. 7-13). The quantization circuitry 1443 may be configured to execute quantization software 1453 included on the computer-readable medium 1406 to implement one or more functions described herein.

The quantization circuitry 1443 may include functionality for a means for communicating with another server (e.g., as described above in conjunction with FIGS. 6-13). For example, the quantization circuitry 1443 may cooperate with the communication and processing circuitry 1441 to communicate with a server associated with a gNB vendor to identify a set of quantization schemes to be used for NN-based encoder and decoder training.

The quantization circuitry 1443 may include functionality for a means for transmitting information (e.g., as described above in conjunction with FIGS. 6-13). For example, the quantization circuitry 1443 may cooperate with the communication and processing circuitry 1441 to transmit an indication of a selected quantization scheme to a server associated with a gNB vendor.

FIG. 15 is a flow chart illustrating an example method 1500 for communication in accordance with some aspects of the present disclosure. As described below, some or all illustrated features may be omitted in a particular implementation within the scope of the present disclosure, and some illustrated features may not be required for implementation of all examples. In some examples, the method 1500 (method for communication) may be carried out by the server 1400 illustrated in FIG. 14. In some examples, the method 1500 may be carried out by any suitable apparatus or means for carrying out the functions or algorithm described below.

At block 1502, a first server may communicate with a second server to identify a set of quantization schemes for encoder and decoder training. In some examples, the quantization circuitry 1443 together with the communication and processing circuitry 1441 and the network interface 1410, shown and described in FIG. 14, may provide a means to communicate with a second server to identify a set of quantization schemes for encoder and decoder training.

At block 1504, the first server may communicate with the second server to conduct the encoder and decoder training. In some examples, the encoding circuitry 1442 together with the communication and processing circuitry 1441 and the network interface 1410, shown and described in FIG. 14, may provide a means to communicate with the second server to conduct the encoder and decoder training.

At block 1506, the first server may transmit, to the second server, codebook information generated by the first server and an indication of a first quantization scheme selected by the first server from the set of quantization schemes. In some examples, the encoding circuitry 1442 and/or quantization circuitry 1443 together with the communication and processing circuitry 1441 and the network interface 1410, shown and described in FIG. 14, may provide a means to transmit, to the second server, codebook information generated by the first server and an indication of a first quantization scheme selected by the first server from the set of quantization schemes.

At block 1508, the first server may transmit encoder information to at least one user equipment associated with the first server, the encoder information being based on the encoder and decoder training, the codebook information, and the first quantization scheme. In some examples, the encoding circuitry 1442, shown and described in FIG. 14 together with the communication and processing circuitry 1441 and the network interface 1410, may provide a means to transmit encoder information to at least one user equipment associated with the first server, the encoder information being based on the encoder and decoder training, the codebook information, and the first quantization scheme.

In some examples, the first server may quantize an output signal of an encoder based on the first quantization scheme to provide a quantized encoder output. In some examples, to communicate with the second server to conduct the encoder and decoder training, the first server may transmit the quantized encoder output to the second server.

In some examples, to communicate with the second server to conduct the encoder and decoder training, the first server may receive, from the second server, a gradient associated with a first layer of a multi-layer decoder of the second server. In some examples, the first server may back propagate the gradient through a multi-layer encoder of the first server. In some examples, the first server may generate the codebook information based on the back propagating of the gradient through the multi-layer encoder of the first server.

In some examples, the encoding and decoding training may involve receiving channel information. In some examples, the first server may receive channel information from the at least one user equipment. In some examples, the first server may generate an expected decoder output based on the channel information. In some examples, the first server may transmit the expected decoder output to the second server for the encoder and decoder training.

In some examples, the first server may select the first quantization scheme from the set of quantization schemes.

In some examples, the encoder and decoder training is for generating encoding information for a neural network encoder associated with the first server. In some examples, the encoder and decoder training is for generating decoding information for a neural network decoder associated with the second server.

FIG. 16 is a flow chart illustrating an example method 1600 for communication in accordance with some aspects of the present disclosure. As described below, some or all illustrated features may be omitted in a particular implementation within the scope of the present disclosure, and some illustrated features may not be required for implementation of all examples. In some examples, the method 1600 (method for wireless communication) may be carried out by the server 1400 illustrated in FIG. 14. In some examples, the method 1600 may be carried out by any suitable apparatus or means for carrying out the functions or algorithm described below.

At block 1602, a first server may communicate with a second server to identify a set of quantization schemes for encoder and decoder training. In some examples, the quantization circuitry 1443 together with the communication and processing circuitry 1441 and the network interface 1410, shown and described in FIG. 14, may provide a means to communicate with a second server to identify a set of quantization schemes for encoder and decoder training.

At block 1604, the first server may communicate with the second server to conduct the encoder and decoder training. In some examples, the encoding circuitry 1442 together with the communication and processing circuitry 1441 and the network interface 1410, shown and described in FIG. 14, may provide a means to communicate with the second server to conduct the encoder and decoder training.

At block 1606, the first server may receive, from the second server, codebook information generated by the second server and an indication of a first quantization scheme selected by the second server from the set of quantization schemes. In some examples, the encoding circuitry 1442 and/or quantization circuitry 1443 together with the communication and processing circuitry 1441 and the network interface 1410, shown and described in FIG. 14, may provide a means to receive, from the second server, codebook information generated by the second server and an indication of a first quantization scheme selected by the second server from the set of quantization schemes.

At block 1608, the first server may transmit encoder information to at least one user equipment associated with the first server, the encoder information being based on the encoder and decoder training, the codebook information, and the first quantization scheme. In some examples, the encoding circuitry 1442, shown and described in FIG. 14 together with the communication and processing circuitry 1441 and the network interface 1410, may provide a means to transmit encoder information to at least one user equipment associated with the first server, the encoder information being based on the encoder and decoder training, the codebook information, and the first quantization scheme.

In some examples, the first server may encode information using a multi-layer encoder to provide an unquantized encoder output signal. In some examples, to communicate with the second server to conduct the encoder and decoder training, the first server may transmit the unquantized encoder output to the second server.

In some examples, to communicate with the second server to conduct the encoder and decoder training, the first server may receive, from the second server, a gradient associated with a first layer of a multi-layer decoder of the second server. In some examples, the first server may back propagate the gradient through a multi-layer encoder of the first server.

In some examples, the first server may receive channel information from the at least one user equipment. In some examples, the first server may generate an expected decoder output based on the channel information. In some examples, the first server may transmit the expected decoder output to the second server for the encoder and decoder training.

In some examples, the encoder and decoder training is for generating encoding information for a neural network encoder associated with the first server. In some examples, the encoder and decoder training is for generating decoding information for a neural network decoder associated with the second server.

Referring again to FIG. 14, in one configuration, the server 1400 includes means for communicating with a second server to identify a set of quantization schemes for encoder and decoder training, means for communicating with the second server to conduct the encoder and decoder training, means for transmitting, to the second server, codebook information generated by the first server and an indication of a first quantization scheme selected by the first server from the set of quantization schemes, and means for transmitting encoder information to at least one user equipment associated with the first server, the encoder information being based on the encoder and decoder training, the codebook information, and the first quantization scheme. In one configuration, the server 1400 includes means for communicating with a second server to identify a set of quantization schemes for encoder and decoder training, means for communicating with the second server to conduct the encoder and decoder training, means for receiving, from the second server, codebook information generated by the second server and an indication of a first quantization scheme selected by the second server from the set of quantization schemes, and means for transmitting encoder information to at least one user equipment associated with the first server, the encoder information being based on the encoder and decoder training, the codebook information, and the first quantization scheme. In one aspect, the aforementioned means may be the processor 1404 shown in FIG. 14 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1404 is merely provided as an example, and other means for carrying out the described functions may be included within various aspects of the present disclosure, including but not limited to the instructions stored in the computer-readable medium 1406, or any other suitable apparatus or means described in any one or more of FIGS. 1, 2, 3, 5, 8, 10, 11, 12, 13, and 14, and utilizing, for example, the methods and/or algorithms described herein in relation to FIGS. 15-16.

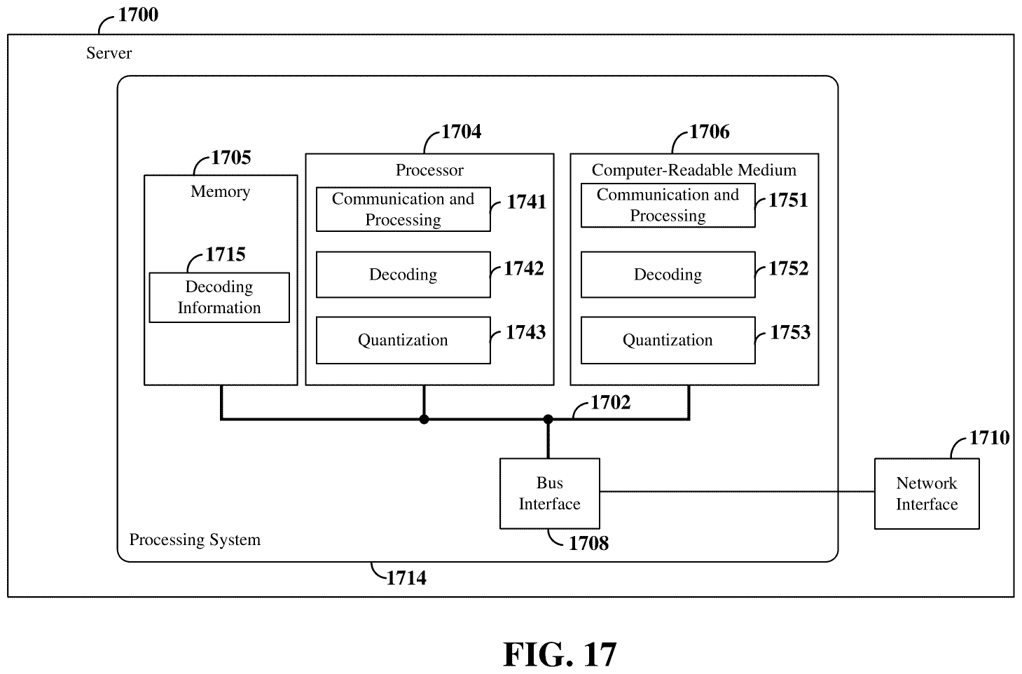

FIG. 17 is a block diagram illustrating an example of a hardware implementation for a server 1700 employing a processing system 1714. In some examples, the server 1700 may be a device configured to communicate with one or more of the network entities, CU, DUs, RUs, base stations, or scheduling entities as discussed in any one or more of FIGS. 1-13. In some implementations, the server 1700 may correspond to any of the servers shown in any of FIGS. 1, 2, 3, 8, 10, 12, and 13. In some examples, the server 1700 may be implemented using one or more server entities (e.g., in a cloud-based server implementation).

In accordance with various aspects of the disclosure, an element, or any portion of an element, or any combination of elements may be implemented with the processing system 1714. The processing system may include one or more processors 1704. The processing system 1714 may be substantially the same as the processing system 1414 illustrated in FIG. 14, including a bus interface 1708, a bus 1702, memory 1705, a processor 1704, a computer-readable medium 1706, and a network interface 1710. The memory 1705 may store encoding information 1715 (e.g., quantization scheme information) used by the processor 1704 for communication operations as described herein. In some examples, the network interface 1710 provides a means for communicating with at least one other apparatus within a core network and with at least one radio access network.

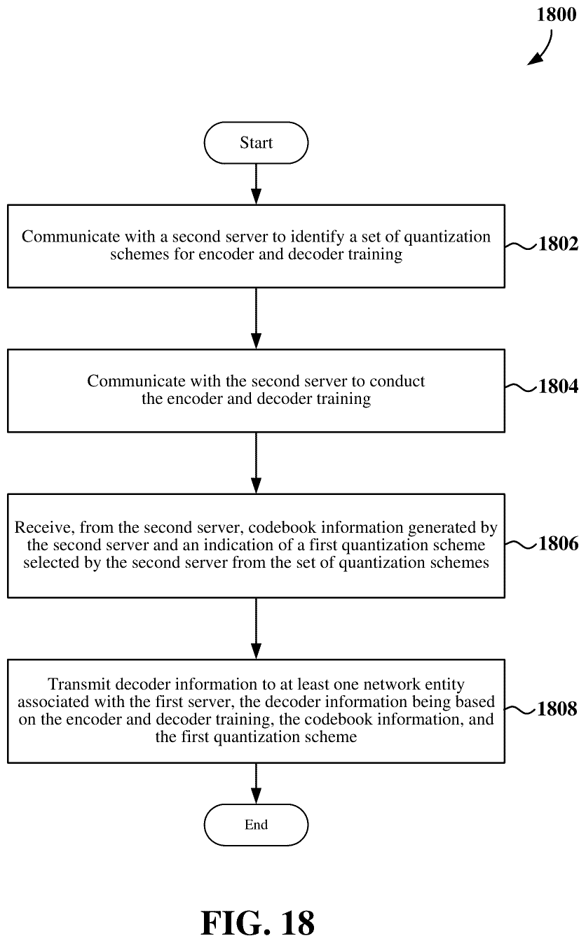

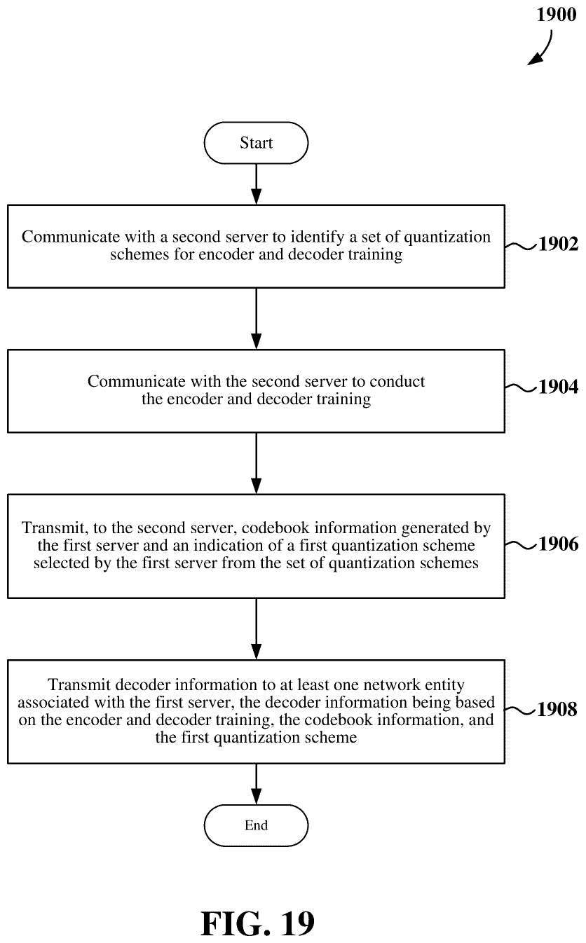

The server 1700 may be configured to perform any one or more of the operations described herein (e.g., as described above in conjunction with FIGS. 1-13 and as described below in conjunction with FIGS. 18 and 19). In some aspects of the disclosure, the processor 1704, as utilized in the server 1700, may include circuitry configured for various functions.

In some aspects of the disclosure, the processor 1704 may include communication and processing circuitry 1741. The communication and processing circuitry 1741 may be configured to communicate with another server and a network entity (e.g., a gNB). The communication and processing circuitry 1741 may include one or more hardware components that provide the physical structure that performs various processes related to communication (e.g., signal reception and/or signal transmission) as described herein. The communication and processing circuitry 1741 may further include one or more hardware components that provide the physical structure that performs various processes related to signal processing (e.g., processing a received signal and/or processing a signal for transmission) as described herein. The communication and processing circuitry 1741 may further be configured to execute communication and processing software 1751 included on the computer-readable medium 1706 to implement one or more functions described herein.

In some implementations wherein the communication involves receiving information, the communication and processing circuitry 1741 may obtain information from a component of the server 1700 (e.g., from the network interface 1710 that receives the information via signaling suitable for the applicable communication medium), process (e.g., decode) the information, and output the processed information. For example, the communication and processing circuitry 1741 may output the information to another component of the processor 1704, to the memory 1705, or to the bus interface 1708. In some examples, the communication and processing circuitry 1741 may receive one or more of signals, messages, other information, or any combination thereof. In some examples, the communication and processing circuitry 1741 may receive information via one or more channels. In some examples, the communication and processing circuitry 1741 may include functionality for a means for receiving. In some examples, the communication and processing circuitry 1741 may include functionality for a means for decoding.

In some implementations wherein the communication involves sending (e.g., transmitting) information, the communication and processing circuitry 1741 may obtain information (e.g., from another component of the processor 1704, the memory 1705, or the bus interface 1708), process (e.g., encode) the information, and output the processed information. For example, the communication and processing circuitry 1741 may output the information to the network interface 1710 (e.g., that transmits the information via signaling suitable for the applicable communication medium). In some examples, the communication and processing circuitry 1741 may send one or more of signals, messages, other information, or any combination thereof. In some examples, the communication and processing circuitry 1741 may send information via one or more channels. In some examples, the communication and processing circuitry 1741 may include functionality for a means for sending (e.g., a means for transmitting). In some examples, the communication and processing circuitry 1741 may include functionality for a means for encoding.

The processor 1704 may include decoding circuitry 1742 configured to perform decoding-related operations as discussed herein (e.g., one or more of the operations described above in conjunction with FIGS. 6-13). The decoding circuitry 1742 may be configured to execute decoding software 1752 included on the computer-readable medium 1706 to implement one or more functions described herein.

The decoding circuitry 1742 may include functionality for a means for communicating with another server (e.g., as described above in conjunction with FIGS. 6-13). For example, the decoding circuitry 1742 may cooperate with the communication and processing circuitry 1741 to communicate with a server associated with a UE vendor to conduct NN-based encoder and decoder training (e.g., receive parameters to be used for training an decoder NN and send parameters generated by the decoder NN during the training).

The decoding circuitry 1742 may include functionality for a means for transmitting information (e.g., as described above in conjunction with FIGS. 6-13). For example, the decoding circuitry 1742 may cooperate with the communication and processing circuitry 1741 to transmit decoder information generated by NN-based decoder training to at least one gNBs associated with the server 1700. As another example, the decoding circuitry 1742 may cooperate with the communication and processing circuitry 1741 to transmit codebook information generated by NN-based decoder training to a server associated with a UE vendor.

The processor 1704 may include quantization circuitry 1743 configured to perform quantization-related operations as discussed herein (e.g., one or more of the operations described above in conjunction with FIGS. 7-13). The quantization circuitry 1743 may be configured to execute quantization software 1753 included on the computer-readable medium 1706 to implement one or more functions described herein.

The quantization circuitry 1743 may include functionality for a means for communicating with another server (e.g., as described above in conjunction with FIGS. 6-13). For example, the quantization circuitry 1743 may cooperate with the communication and processing circuitry 1741 to communicate with a server associated with a gNB vendor to identify a set of quantization schemes to be used for NN-based encoder and decoder training.

The quantization circuitry 1743 may include functionality for a means for transmitting information (e.g., as described above in conjunction with FIGS. 6-13). For example, the quantization circuitry 1743 may cooperate with the communication and processing circuitry 1741 to transmit an indication of a selected quantization scheme to a server associated with a gNB vendor.

FIG. 18 is a flow chart illustrating an example method 1800 for communication in accordance with some aspects of the present disclosure. As described below, some or all illustrated features may be omitted in a particular implementation within the scope of the present disclosure, and some illustrated features may not be required for implementation of all examples. In some examples, the method 1800 (method for wireless communication) may be carried out by the server 1700 illustrated in FIG. 17. In some examples, the method 1800 may be carried out by any suitable apparatus or means for carrying out the functions or algorithm described below.

At block 1802, a first server may communicate with a second server to identify a set of quantization schemes for encoder and decoder training. In some examples, the quantization circuitry 1743 together with the communication and processing circuitry 1741 and the network interface 1710, shown and described in FIG. 17, may provide a means to communicate with a second server to identify a set of quantization schemes for encoder and decoder training.

At block 1804, the first server may communicate with the second server to conduct the encoder and decoder training. In some examples, the decoding circuitry 1742 together with the communication and processing circuitry 1741 and the network interface 1710, shown and described in FIG. 17, may provide a means to communicate with the second server to conduct the encoder and decoder training.

At block 1806, the first server may receive, from the second server, codebook information generated by the second server and an indication of a first quantization scheme selected by the second server from the set of quantization schemes. In some examples, the decoding circuitry 1742 and/or quantization circuitry 1743 together with the communication and processing circuitry 1741 and the network interface 1710, shown and described in FIG. 17, may provide a means to receive, from the second server, codebook information generated by the second server and an indication of a first quantization scheme selected by the second server from the set of quantization schemes.

At block 1808, the first server may transmit decoder information to at least one network entity associated with the first server, the decoder information being based on the encoder and decoder training, the codebook information, and the first quantization scheme. In some examples, the decoding circuitry 1742, shown and described in FIG. 17 together with the communication and processing circuitry 1741 and the network interface 1710, may provide a means to transmit decoder information to at least one network entity associated with the first server, the decoder information being based on the encoder and decoder training, the codebook information, and the first quantization scheme.

In some examples, to communicate with the second server to conduct the encoder and decoder training, the first server may receive a quantized encoder output signal from the second server. In some examples, the encoder and decoder training may involve inputting information to a multi-layer decoder of the first server. In some examples, the first server may input the quantized encoder output signal to a multi-layer decoder of the first server. In some examples, the first server may generate a loss function based on an output of the multi-layer decoder. In some examples, the first server may back propagate a first gradient based on the loss function through the multi-layer decoder. In some examples, to communicate with the second server to conduct the encoder and decoder training, the first server may transmit, to the second server, a second gradient associated with a first layer of the multi-layer decoder.

In some examples, the encoder and decoder training is for generating encoding information for a neural network encoder associated with the second server. In some examples, the encoder and decoder training is for generating decoding information for a neural network decoder associated with the first server.

FIG. 19 is a flow chart illustrating an example method 1900 for communication in accordance with some aspects of the present disclosure. As described below, some or all illustrated features may be omitted in a particular implementation within the scope of the present disclosure, and some illustrated features may not be required for implementation of all examples. In some examples, the method 1900 (method for wireless communication) may be carried out by the server 1700 illustrated in FIG. 17. In some examples, the method 1900 may be carried out by any suitable apparatus or means for carrying out the functions or algorithm described below.

At block 1902, a first server may communicate with a second server to identify a set of quantization schemes for encoder and decoder training. In some examples, the quantization circuitry 1743 together with the communication and processing circuitry 1741 and the network interface 1710, shown and described in FIG. 17, may provide a means to communicate with a second server to identify a set of quantization schemes for encoder and decoder training.

At block 1904, the first server may communicate with the second server to conduct the encoder and decoder training. In some examples, the decoding circuitry 1742 together with the communication and processing circuitry 1741 and the network interface 1710, shown and described in FIG. 17, may provide a means to communicate with the second server to conduct the encoder and decoder training.

At block 1906, the first server may transmit, to the second server, codebook information generated by the first server and an indication of a first quantization scheme selected by the first server from the set of quantization schemes. In some examples, the decoding circuitry 1742 and/or quantization circuitry 1743 together with the communication and processing circuitry 1741 and the network interface 1710, shown and described in FIG. 17, may provide a means to transmit, to the second server, codebook information generated by the first server and an indication of a first quantization scheme selected by the first server from the set of quantization schemes.

At block 1908, the first server may transmit decoder information to at least one network entity associated with the first server, the decoder information being based on the encoder and decoder training, the codebook information, and the first quantization scheme. In some examples, the decoding circuitry 1742, shown and described in FIG. 17 together with the communication and processing circuitry 1741 and the network interface 1710, may provide a means to transmit decoder information to at least one network entity associated with the first server, the decoder information being based on the encoder and decoder training, the codebook information, and the first quantization scheme.

In some examples, to communicate with the second server to conduct the encoder and decoder training, the first server may receive an unquantized encoder output signal from the second server. In some examples, the first server may quantize the unquantized encoder output signal based on the first quantization scheme to provide a quantized encoder output signal. In some examples, the first server may input the quantized encoder output signal to a multi-layer decoder of the first server. In some examples, the first server may generate a loss function based on an output of the multi-layer decoder. In some examples, the first server may back propagate a first gradient based on the loss function through the multi-layer decoder. In some examples, the first server may generate the codebook information based on the back propagating of the first gradient through the multi-layer decoder. In some examples, to communicate with the second server to conduct the encoder and decoder training, the first server may transmit, to the second server, a second gradient associated with a first layer of the multi-layer decoder.

In some examples, the first server may select the first quantization scheme from the set of quantization schemes.

In some examples, the encoder and decoder training is for generating encoding information for a neural network encoder associated with the second server. In some examples, the encoder and decoder training is for generating decoding information for a neural network decoder associated with the first server.

Referring again to FIG. 17, in one configuration, the server 1700 includes means for communicating with a second server to identify a set of quantization schemes for encoder and decoder training, means for communicating with the second server to conduct the encoder and decoder training, means for receiving, from the second server, codebook information generated by the second server and an indication of a first quantization scheme selected by the second server from the set of quantization schemes, and means for transmitting decoder information to at least one network entity associated with the first server, the decoder information being based on the encoder and decoder training, the codebook information, and the first quantization scheme. In one configuration, the server 1700 includes means for communicating with a second server to identify a set of quantization schemes for encoder and decoder training, means for communicating with the second server to conduct the encoder and decoder training, means for transmitting, to the second server, codebook information generated by the first server and an indication of a first quantization scheme selected by the first server from the set of quantization schemes, and means for transmitting decoder information to at least one network entity associated with the first server, the decoder information being based on the encoder and decoder training, the codebook information, and the first quantization scheme. In one aspect, the aforementioned means may be the processor 1704 shown in FIG. 17 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1704 is merely provided as an example, and other means for carrying out the described functions may be included within various aspects of the present disclosure, including but not limited to the instructions stored in the computer-readable medium 1706, or any other suitable apparatus or means described in any one or more of FIGS. 1, 2, 3, 5, 8, 10, 11, 12, 13, and 17, and utilizing, for example, the methods and/or algorithms described herein in relation to FIGS. 18-19.

The methods shown in FIGS. 15-16 and 18-19 may include additional aspects, such as any single aspect or any combination of aspects described below and/or in connection with one or more other processes described elsewhere herein. The following provides an overview of several aspects of the present disclosure.

Aspect 1: A method for communication at a first server, the method comprising: communicating with a second server to identify a set of quantization schemes for encoder and decoder training; communicating with the second server to conduct the encoder and decoder training; transmitting, to the second server, codebook information generated by the first server and an indication of a first quantization scheme selected by the first server from the set of quantization schemes; and transmitting encoder information to at least one user equipment associated with the first server, the encoder information being based on the encoder and decoder training, the codebook information, and the first quantization scheme.

Aspect 2: The method of aspect 1, further comprising: quantizing an output signal of an encoder based on the first quantization scheme to provide a quantized encoder output.

Aspect 3: The method of aspect 2, wherein the communicating with the second server to conduct the encoder and decoder training comprises: transmitting the quantized encoder output to the second server.

Aspect 4: The method of any of aspects 1 through 3, wherein: the communicating with the second server to conduct the encoder and decoder training comprises receiving, from the second server, a gradient associated with a first layer of a multi-layer decoder of the second server; and the method further comprises back propagating the gradient through a multi-layer encoder of the first server.

Aspect 5: The method of aspect 4, further comprising: generating the codebook information based on the back propagating of the gradient through the multi-layer encoder of the first server.

Aspect 6: The method of any of aspects 1 through 5, further comprising: receiving channel information from the at least one user equipment; generating an expected decoder output based on the channel information; and transmitting the expected decoder output to the second server for the encoder and decoder training.

Aspect 7: The method of any of aspects 1 through 6, further comprising: selecting the first quantization scheme from the set of quantization schemes.

Aspect 8: The method of any of aspects 1 through 7, wherein the encoder and decoder training is for generating: encoding information for a neural network encoder associated with the first server; and decoding information for a neural network decoder associated with the second server.

Aspect 9: A method for communication at a first server, the method comprising: communicating with a second server to identify a set of quantization schemes for encoder and decoder training; communicating with the second server to conduct the encoder and decoder training; receiving, from the second server, codebook information generated by the second server and an indication of a first quantization scheme selected by the second server from the set of quantization schemes; and transmitting decoder information to at least one network entity associated with the first server, the decoder information being based on the encoder and decoder training, the codebook information, and the first quantization scheme.

Aspect 10: The method of aspect 9, wherein the communicating with the second server to conduct the encoder and decoder training comprises: receiving a quantized encoder output signal from the second server.

Aspect 11: The method of aspect 10, further comprising: inputting the quantized encoder output signal to a multi-layer decoder of the first server.

Aspect 12: The method of aspect 11, further comprising: generating a loss function based on an output of the multi-layer decoder.

Aspect 13: The method of aspect 12, further comprising: back propagating a first gradient based on the loss function through the multi-layer decoder.

Aspect 14: The method of aspect 13, wherein the communicating with the second server to conduct the encoder and decoder training comprises: transmitting, to the second server, a second gradient associated with a first layer of the multi-layer decoder.

Aspect 15: The method of any of aspects 9 through 14, wherein the encoder and decoder training is for generating: encoding information for a neural network encoder associated with the second server; and decoding information for a neural network decoder associated with the first server.

Aspect 16: A method for communication at a first server, the method comprising: communicating with a second server to identify a set of quantization schemes for encoder and decoder training; communicating with the second server to conduct the encoder and decoder training; receiving, from the second server, codebook information generated by the second server and an indication of a first quantization scheme selected by the second server from the set of quantization schemes; and transmitting encoder information to at least one user equipment associated with the first server, the encoder information being based on the encoder and decoder training, the codebook information, and the first quantization scheme.

Aspect 17: The method of aspect 16, further comprising: encoding information using a multi-layer encoder to provide an unquantized encoder output signal.

Aspect 18: The method of aspect 17, wherein the communicating with the second server to conduct the encoder and decoder training comprises: transmitting the unquantized encoder output signal to the second server.

Aspect 19: The method of aspect 18, wherein: the communicating with the second server to conduct the encoder and decoder training comprises receiving, from the second server, a gradient associated with a first layer of a multi-layer decoder of the second server; and the method further comprises back propagating the gradient through a multi-layer encoder of the first server.

Aspect 20: The method of any of aspects 16 through 19, further comprising: receiving channel information from the at least one user equipment; generating an expected decoder output based on the channel information; and transmitting the expected decoder output to the second server for the encoder and decoder training.

Aspect 21: The method of any of aspects 16 through 20, wherein the encoder and decoder training is for generating: encoding information for a neural network encoder associated with the first server; and decoding information for a neural network decoder associated with the second server.

Aspect 22: A method for communication at a first server, the method comprising: communicating with a second server to identify a set of quantization schemes for encoder and decoder training; communicating with the second server to conduct the encoder and decoder training; transmitting, to the second server, codebook information generated by the first server and an indication of a first quantization scheme selected by the first server from the set of quantization schemes; and transmitting decoder information to at least one network entity associated with the first server, the decoder information being based on the encoder and decoder training, the codebook information, and the first quantization scheme.

Aspect 23: The method of aspect 22, wherein the communicating with the second server to conduct the encoder and decoder training comprises: receiving an unquantized encoder output signal from the second server.

Aspect 24: The method of aspect 23, further comprising: quantizing the unquantized encoder output signal based on the first quantization scheme to provide a quantized encoder output signal; and inputting the quantized encoder output signal to a multi-layer decoder of the first server.

Aspect 25: The method of aspect 24, further comprising: generating a loss function based on an output of the multi-layer decoder.

Aspect 26: The method of aspect 25, further comprising: back propagating a first gradient based on the loss function through the multi-layer decoder.

Aspect 27: The method of aspect 26, further comprising: generating the codebook information based on the back propagating of the first gradient through the multi-layer decoder.

Aspect 28: The method of any of aspects 26 through 27, wherein the communicating with the second server to conduct the encoder and decoder training comprises: transmitting, to the second server, a second gradient associated with a first layer of the multi-layer decoder.

Aspect 29: The method of any of aspects 22 through 28, further comprising: selecting the first quantization scheme from the set of quantization schemes.

Aspect 30: The method of any of aspects 22 through 29, wherein the encoder and decoder training is for generating: encoding information for a neural network encoder associated with the second server; and decoding information for a neural network decoder associated with the first server.

Aspect 31: A first server comprising: a transceiver configured to communicate with a radio access network, a memory, and a processor coupled to the transceiver and the memory, wherein the processor and the memory are configured to perform any one or more of aspects 1 through 8.

Aspect 32: An apparatus configured for wireless communication comprising at least one means for performing any one or more of aspects 1 through 8.

Aspect 33: A non-transitory computer-readable medium storing computer-executable code, comprising code for causing an apparatus to perform any one or more of aspects 1 through 8.

Aspect 34: A first server comprising: a transceiver configured to communicate with a radio access network, a memory, and a processor coupled to the transceiver and the memory, wherein the processor and the memory are configured to perform any one or more of aspects 9 through 15.

Aspect 35: An apparatus configured for wireless communication comprising at least one means for performing any one or more of aspects 9 through 15.

Aspect 36: A non-transitory computer-readable medium storing computer-executable code, comprising code for causing an apparatus to perform any one or more of aspects 9 through 15.

Aspect 37: A first server comprising: a transceiver, a memory, and a processor coupled to the transceiver and the memory, wherein the processor and the memory are configured to perform any one or more of aspects 16 through 21.

Aspect 38: An apparatus configured for wireless communication comprising at least one means for performing any one or more of aspects 16 through 21.

Aspect 39: A non-transitory computer-readable medium storing computer-executable code, comprising code for causing an apparatus to perform any one or more of aspects 16 through 21.

Aspect 40: A first server comprising: a transceiver, a memory, and a processor coupled to the transceiver and the memory, wherein the processor and the memory are configured to perform any one or more of aspects 22 through 30.

Aspect 41: An apparatus configured for wireless communication comprising at least one means for performing any one or more of aspects 22 through 30.

Aspect 42: A non-transitory computer-readable medium storing computer-executable code, comprising code for causing an apparatus to perform any one or more of aspects 22 through 30.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-19 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 3, 5, 8, 10, 11, 12, 13, 14, and 17 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for communication at a first server, the method comprising:
communicating with a second server to identify a set of quantization schemes for encoder and decoder training;
communicating with the second server to conduct the encoder and decoder training;
transmitting, to the second server, codebook information generated by the first server and an indication of a first quantization scheme selected by the first server from the set of quantization schemes; and
transmitting encoder information to at least one user equipment associated with the first server, the encoder information being based on the encoder and decoder training, the codebook information, and the first quantization scheme.

2. The method of claim 1, further comprising:
quantizing an output signal of an encoder based on the first quantization scheme to provide a quantized encoder output.

3. The method of claim 2, wherein the communicating with the second server to conduct the encoder and decoder training comprises:
transmitting the quantized encoder output to the second server.

4. The method of claim 1, wherein:
the communicating with the second server to conduct the encoder and decoder training comprises receiving, from the second server, a gradient associated with a first layer of a multi-layer decoder of the second server; and
the method further comprises back propagating the gradient through a multi-layer encoder of the first server.

5. The method of claim 4, further comprising:
generating the codebook information based on the back propagating of the gradient through the multi-layer encoder of the first server.

6. The method of claim 1, further comprising:
receiving channel information from the at least one user equipment;
generating an expected decoder output based on the channel information; and
transmitting the expected decoder output to the second server for the encoder and decoder training.

7. The method of claim 1, further comprising:
selecting the first quantization scheme from the set of quantization schemes.

8. The method of claim 1, wherein the encoder and decoder training is for generating:
encoding information for a neural network encoder associated with the first server; and
decoding information for a neural network decoder associated with the second server.

9. A method for communication at a first server, the method comprising:
communicating with a second server to identify a set of quantization schemes for encoder and decoder training;
communicating with the second server to conduct the encoder and decoder training;
receiving, from the second server, codebook information generated by the second server and an indication of a first quantization scheme selected by the second server from the set of quantization schemes; and
transmitting decoder information to at least one network entity associated with the first server, the decoder information being based on the encoder and decoder training, the codebook information, and the first quantization scheme.

10. The method of claim 9, wherein the communicating with the second server to conduct the encoder and decoder training comprises:
receiving a quantized encoder output signal from the second server.

11. The method of claim 10, further comprising:
inputting the quantized encoder output signal to a multi-layer decoder of the first server.

12. The method of claim 11, further comprising:
generating a loss function based on an output of the multi-layer decoder.

13. The method of claim 12, further comprising:
back propagating a first gradient based on the loss function through the multi-layer decoder.

14. The method of claim 13, wherein the communicating with the second server to conduct the encoder and decoder training comprises:
transmitting, to the second server, a second gradient associated with a first layer of the multi-layer decoder.

15. The method of claim 1, wherein the encoder and decoder training is for generating:
encoding information for a neural network encoder associated with the second server; and
decoding information for a neural network decoder associated with the first server.

16. A method for communication at a first server, the method comprising:
communicating with a second server to identify a set of quantization schemes for encoder and decoder training;
communicating with the second server to conduct the encoder and decoder training;
receiving, from the second server, codebook information generated by the second server and an indication of a first quantization scheme selected by the second server from the set of quantization schemes; and
transmitting encoder information to at least one user equipment associated with the first server, the encoder information being based on the encoder and decoder training, the codebook information, and the first quantization scheme.

17. The method of claim 16, further comprising:
encoding information using a multi-layer encoder to provide an unquantized encoder output signal.

18. The method of claim 17, wherein the communicating with the second server to conduct the encoder and decoder training comprises:
transmitting the unquantized encoder output signal to the second server.

19. The method of claim 18, wherein:
the communicating with the second server to conduct the encoder and decoder training comprises receiving, from the second server, a gradient associated with a first layer of a multi-layer decoder of the second server; and
the method further comprises back propagating the gradient through a multi-layer encoder of the first server.

20. The method of claim 16, further comprising:
receiving channel information from the at least one user equipment;
generating an expected decoder output based on the channel information; and
transmitting the expected decoder output to the second server for the encoder and decoder training.

21. The method of claim 16, wherein the encoder and decoder training is for generating:
encoding information for a neural network encoder associated with the first server; and
decoding information for a neural network decoder associated with the second server.

22. A method for communication at a first server, the method comprising:
communicating with a second server to identify a set of quantization schemes for encoder and decoder training;
communicating with the second server to conduct the encoder and decoder training;
transmitting, to the second server, codebook information generated by the first server and an indication of a first quantization scheme selected by the first server from the set of quantization schemes; and
transmitting decoder information to at least one network entity associated with the first server, the decoder information being based on the encoder and decoder training, the codebook information, and the first quantization scheme.

23. The method of claim 22, wherein the communicating with the second server to conduct the encoder and decoder training comprises:
receiving an unquantized encoder output signal from the second server.

24. The method of claim 23, further comprising:
quantizing the unquantized encoder output signal based on the first quantization scheme to provide a quantized encoder output signal; and
inputting the quantized encoder output signal to a multi-layer decoder of the first server.

25. The method of claim 24, further comprising:
generating a loss function based on an output of the multi-layer decoder.

26. The method of claim 25, further comprising:
back propagating a first gradient based on the loss function through the multi-layer decoder.

27. The method of claim 26, further comprising:
generating the codebook information based on the back propagating of the first gradient through the multi-layer decoder.

28. The method of claim 26, wherein the communicating with the second server to conduct the encoder and decoder training comprises:
transmitting, to the second server, a second gradient associated with a first layer of the multi-layer decoder.

29. The method of claim 22, further comprising:
selecting the first quantization scheme from the set of quantization schemes.

30. The method of claim 22, wherein the encoder and decoder training is for generating:
encoding information for a neural network encoder associated with the second server; and
decoding information for a neural network decoder associated with the first server.
